(19) United States
(12) Patent Application Publication
(10) Pub. No.: US 2008/0277423 A1
(43) Pub. Date: Nov. 13, 2008

(54) HOPPER WITH SLIDE DISCHARGE GATE AND METHOD MAKING THE SAME

(75) Inventor: Darwin Garton, Lincoln, NE (US)

Correspondence Address: HOVEY WILLIAMS LLP, 10801 Mastin Blvd., Suite 1000, Overland Park, KS, 66210, US

(73) Assignee: SNYDER INDUSTRIES, INC., Lincoln, NE (US)

(21) Appl. No.: 12/117,251

(22) Filed: May 8, 2008

Related U.S. Application Data
(60) Provisional application No. 60/917,017, filed on May 9, 2007.

(51) Int. Cl. B67D 5/06; B65D 25/00; B29C 41/04; B29C 41/38; B65D 47/00

(52) U.S. Cl. 222/185.1; 29/592; 248/346.01; 425/435; 264/297.8; 222/561

(57) ABSTRACT

A hopper bin assembly with a slide discharge gate comprises a hopper section, a slide gate housing, and a pallet. The hopper stores a volume of dry material and includes an outlet. The slide gate housing couples with the hopper and includes a discharge opening that aligns with the outlet of the hopper. A slidable gate that is coupled with the discharge opening controls the flow of material through the discharge opening. The pallet supports the slide gate housing and the hopper and includes openings that receive the forks of a forklift. A method of making at least a portion of the hopper bin assembly includes rotating a resin in a mold along two or more axes within a heated room or chamber. The mold is cooled and the part formed therein is separated into one or more sections.

### RELATED APPLICATION

This nonprovisional patent application claims priority benefit, with regard to all common subject matter, of earlier-filed U.S. provisional patent application titled “HOPPER WITH SLIDE DISCHARGE GATE AND METHOD OF MAKING THE SAME”, Ser. No. 60/917,017, filed May 9, 2007. The identified earlier-filed application is hereby incorporated by reference in its entirety into the present application.

### BACKGROUND OF THE INVENTION

1. Field of the Invention

This invention concerns a method for forming an improved dry material hopper bin by rotational molding. More particularly, it is concerned with a process whereby the hopper bin and portions of the outlet valve are molded as an integral piece. This invention further concerns a method for forming two pieces of a rotationally molded storage container, such as a dry material hopper assembly, from a single mold. In addition, it is concerned with a process for interconnecting two molding compartments to form two different components during a single process.

2. Description of the Prior Art

Rotational molding, as recognized by those in the art, is a process which is useful in forming parts from synthetic resin materials. The process of rotational molding is characterized by the provision of a mold separable into at least two mold sections, into which synthetic resin, such as polyethylene, is placed. Although heated liquid synthetic resin can be employed, the synthetic resin is typically provided in powdered or other solid form. By heating the mold within an oven-like chamber while the mold is rotated, preferably around more than one axis, the synthetic resin particles are distributed throughout the mold, thereafter melting to a gooey consistency when engaging the heated mold. The rotation of the mold results in the resin particles being substantially evenly distributed, with the resin filling in cavities in the mold and conforming to the interior configuration of the mold. Once the melting and distribution is complete, the mold is removed from the oven and cooled while rotation continues. Such cooling may be in ambient air temperature, but in any event below the melting point of the synthetic resin, or accelerated by the use of cooling water in hot environments.

Heretofore, when making dry material handling hopper bins, the outlet housing has typically been made separately from the container, as well as various portions of the valve assembly associated with the outlet housing, thus requiring a number of steps to manufacture, higher equipment and labor costs, and close observance of engineering tolerances to ensure compatibility and proper assembly of the components into a finished product. Often, many joints are required, increasing the cost of manufacture. Further, the construction material of the bin and of the outlet housing are often different, increasing the possibility that the contents of the bin could be adversely affected by the housing material, or that the relative properties of the materials, such as thermal expansion, may lead to problems in assembly or use. Conventional manufacturing of dry material bin hoppers and outlet valves require purchasing a valve as a complete separate unit, and then bolting or otherwise securing the valve to the outlet portion of the hopper bin, which increases costs and time involved to construct the hopper bin. In addition, multiple molding processes and trimming are often employed for each component of the hopper bins, involving many steps, resulting in large amounts of time and high costs of manufacture.

### SUMMARY OF THE INVENTION

It is a goal of the present invention to provide a bulk container, and in particular a dry material hopper, in an economical and cost-effective construction and method. The demands for an improved and economical rotational molding process for creating resinous storage containers, and in particular an improved dry material handling hopper bin and a process for making the same, have largely been met by the present invention.

In one aspect of the present invention an outlet housing and a support for a transverse slide gate across the housing are all molded as one integral body with the hopper bin, limiting production costs to the small amount of additional material required to mold those portions of the valve outlet housing and support structure, and eliminating the need for any additional joints to secure the outlet housing to the body of the bin. Furthermore, by constructing the bin and the outlet housing out of the same material, the housing material does not adversely affect the compatibility between the bin and the contents. In addition, as the number of fasteners is minimal in the design of the present invention, as is the amount of metal utilized, the cost associated with using exotic materials sometimes needed to adapt the product to materials which react negatively with metal is greatly reduced.

The actual sliding gate used can be made from a multitude of different materials, and in different thicknesses and shape configurations, without affecting the way the outlet housing is made, as the housing can easily be trimmed to accommodate such variances as needed. In addition, a secondary seal can be added to seal the gate when necessary, as when transporting of hazardous material.

The design of the present invention is highly adaptable, and can be conformed easily to any slope hopper, or even to hoppers other than flat shaped hoppers, such as cone or dome bottom shapes, and can also be adapted for various sizes of outlet housings and gates to accommodate a wide variety of applications. Another advantage of the present invention is that, by changing the shape of the bottom section of the housing which is trimmed to create the gate support structure, the support structure can incorporate slopes for improved drainage of material, if necessary.

In making a hopper container in accordance with the teachings of the present invention, the resin is deposited within the mold and the latter is securely closed and coupled to a conventional rotational molding machine. The mold is rotated on two or more axes to thoroughly distribute the resin throughout the mold, and is inserted into a heated room or chamber. Once the resin becomes molten and viscous so as to thoroughly and evenly coat the interior of the mold, the mold is cooled. After cooling the mold and the part formed therein to a sufficient temperature, the mold, typically in two or more mold sections, is removed from the rotational molding machine and separated. In one advantageous application of the present invention, the mold is configured so that the resultant molded hollow body presents an extension which is stepped in a series of progressively smaller, but similar shapes. Such an extension is useful in forming a bin outlet housing, typically located at the bottom end of the completed hopper.

Once molding of the hollow body is completed, an opening is first cut or otherwise formed in the bottom end, generally in the same shape as the cross-sectional shape of the bin outlet housing, and this cutout portion can be discarded, leaving the opening exposed. Two generally parallel, transverse cuts are then made across successive longitudinal portions of the outlet housing, forming an offset transition area cut-off piece which can be discarded, and a now separate rectangular annulus which will be used as a support for the slide gate.

A first slot is formed in the front wall of the remaining outlet housing, for example by cutting with a saw, a heat cutter, a router or the like, to form an opening for the slide gate. A second slot is then formed in the opposed rear wall of the sleeve by similar means in alignment with the first slot, both side to side and front to rear. This second slot forms an opening adapted to receive a guide tongue of the slide gate.

The saved rectangular annulus from the trimmed integrally molded body is inverted 180° from the position it was in as a portion of the body. The annulus is then inserted upwardly into the outlet housing until the top surface of the annulus is positioned flush with the bottom of corresponding front and rear slots. The outer walls of the annulus are positioned closely adjacent the inner surface of the outlet housing and then secured to the housing to prevent shifting.

A slide gate is positioned in the outlet housing by passing a narrow tongue portion of the slide gate through the first slot, across the outlet and then at least partially through the second slot. The side margins of the gate overlie the inverted annulus at this time such that the inverted annulus serves as a support platform for the gate.

A secondary seal can be provided by means of a seal plate secured to the outer surface of the outlet housing adjacent the first and/or second slots, which seal extends along three sides of the slide gate or its tongue portion, accounting for any tolerances which may exist between the slots and the slide gate. In use, the outlet presented by the outlet housing can be selectively closed by shifting the gate such that the planar portion thereof is fully across the outlet.

In another aspect, the present invention includes a two-piece rotationally molded base for a dry material handling hopper bin. Such base includes two primary parts, both of which are rotationally molded in a single mold having a pair of interconnected compartments, wherein all the material for both pieces is put into one of the mold sections for subsequent flow into the other compartment as well through tubular connector elements between the compartments comprising or including non-stick surfaces. This two compartment mold utilizes one rotational molding process to form two distinctive parts that, when joined to one another via fasteners, form a complete base with features that otherwise would be more difficult and costly to manufacture.

A first piece of the base comprises an outlet housing that contains sloping interior walls to form the hopper-like bottom of the dry bin when the bin is places on the base. The housing also includes transverse openings for a horizontally shiftable slide gate. When coupled with the second, pallet piece to complete the base, a fork lift pocket arrangement is presented which provides an anti-teeter feature for the device, helping stabilize the bin during sudden stops or on downhill slopes while on the forklift.

In additional aspects of the present invention, the molding process also includes a technique by which openings are selectively formed, while maintaining required tolerances, by utilizing a non-stick block, such as polytetrafluoroethylene or the like, which is secured to desired positions on the mold, creating areas where resin is prevented by the block from adhering to the mold during the rotational molding process.

A container which utilizes a base that is initially separately molded apart from the main sleeve of the bin is economical to produce since any one of a number of different height sleeves can be selectively mounted on the same, common-size base. In this manner the expense associated with having molds of different heights that contain both sleeve portions and base portions can be avoided. As the bin sleeve tooling is considerably less costly than the base tooling, it is a significant that in accordance with the present invention the base mold tooling does not have to be repeated for each height of sleeve. The length of the sleeve can be readily adjusted by simply adding a tubular extension to or removing it from the basic mold for the sleeve.

In accordance with this aspect of the invention, the resin is deposited within one of the two compartments of the mold, after which the mold is securely closed and coupled to a conventional rotational molding machine. The mold is rotated on two or more axes to thoroughly distribute the resin throughout both compartments of the mold, as the resin flows through a tubular coupling spacer that communicates the interiors of the two compartments with one another. The mold is then inserted into a heated room or chamber. Once the resin becomes molten and viscous, it thoroughly and evenly coats the interior of the mold, with the exception of those places where a non-stick block or coating is employed, including the site of the slide gate opening and along the inside of the coupling spacers. After the mold and the parts formed therein are cooled to a sufficiently low temperature, the mold, typically in two or more mold sections for each compartment, is removed from the rotational molding machine and separated. The molded parts can then be removed, and are fastened together to form the slide gate housing and the pallet of the present two-piece base.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Embodiments of the present invention is described in detail below with reference to the attached drawing figures, wherein:

FIG. 1 is a schematic view of a molding machine used in rotational molding;

FIG. 2 is a perspective view of a dispensing hopper container constructed in accordance with the principles of the present invention and positioned on a support frame;

FIG. 3 is a perspective view of a rotationally molded body after leaving the mold and before trimming operations to convert the body into a final product;

FIG. 4 is a fragmentary perspective view of the body after trimming operations but before removing the trimmed pieces from the bottom of the body to illustrate the locations for the trimming cuts;

FIG. 5 is a fragmentary side elevational view of the body after trimming operations but before removing the trimmed pieces as in FIG. 4, portions of the exterior of the body being broken away to reveal details of construction;

FIG. 6 is a fragmentary exploded view of the container with trimmed offset portion removed but before the lower annulus portion is inverted and inserted into the outlet housing;

FIG. 7 is a fragmentary perspective view of the trimmed container after preparing slide gate slots in its outlet housing, and schematically depicting the trimmed annulus in the process of being inverted 180° for insertion into the outlet housing;

FIG. 8 is a fragmentary perspective view of the trimmed lower portion of the container after the annulus previously trimmed from the body has been inverted 180° and inserted into the outlet housing of the hopper to form the gate slide support;

FIG. 9 is a fragmentary front perspective view of the lower end of the container illustrating details of the slide gate valve assembly, the slide gate being shown in an open position;

FIG. 10 is a fragmentary, top rear perspective view of the lower end of the container illustrating details of the slide gate valve assembly, the slide gate being shown in an open position;

FIG. 11 is a fragmentary bottom perspective view of the lower end of the container illustrating the slide gate in a closed position;

FIG. 12 is a fragmentary top plan view of the lower end of the container showing the slide gate in the open position;

FIG. 13 is an enlarged, fragmentary vertical sectional view taken substantially along line 13-13 of FIG. 12;

FIG. 14 is a fragmentary vertical sectional view taken substantially along line 14-14 of FIG. 12;

FIG. 15 is a fragmentary front perspective view of the lower end of the container showing another embodiment of the gate slide support;

FIG. 16 is an enlarged, fragmentary vertical sectional view taken substantially along line 16-16 of FIG. 15;

FIG. 17 is an enlarged, fragmentary vertical sectional view taken substantially along line 17-17 of FIG. 15;

FIG. 18 is a top perspective view of a dry material handling hopper bin and two-piece base in accordance with another aspect of the invention;

FIG. 19 is a bottom perspective view of the bin and base of FIG. 18;

FIG. 20 is an exploded top perspective view of a rotational mold used in making the two-piece base of the bin of FIG. 18;

FIG. 21 is an exploded bottom perspective view of the rotational mold of FIG. 20;

FIG. 22 is an exploded bottom perspective view of the rotational mold of FIG. 20, showing an alternative coupling joining upper and lower portions of the mold;

FIG. 23 is a top perspective view of the rotational mold of FIG. 20 in its assembled form;

FIG. 24 is a bottom perspective view of the rotational mold in its assembled form;

FIG. 25 is a top plan view of the rotational mold in its assembled form;

FIG. 26 is a front elevational view of the rotational mold in its assembled form;

FIG. 27 is a side elevational view of the rotational mold in its assembled form;

FIG. 28 is an enlarged, fragmentary vertical sectional view taken along line 28-28 of FIG. 26, showing the mold having resin deposited therein, with the two mold compartments coupled by means of a coupling spacer, the coupling spacer including a non-stick block on the inner surface thereof;

FIG. 29 is a top perspective view of the outlet housing piece of the two-piece base of the present invention;

FIG. 30 is a bottom perspective view of the outlet housing;

FIG. 31 is a top perspective view of the pallet piece of the two-piece base of the present invention;

FIG. 32 is an enlarged, fragmentary sectional view taken substantially along line 32-32 of FIG. 18, showing the shape of the pallet and the connection of the pallet section to slide gate housing;

FIG. 33 is a bottom perspective view of the pallet;

FIG. 34 is a top perspective view of the dry material handling hopper bin and two-piece base in accordance with yet another aspect of the invention;

FIG. 35 is a fragmentary view taken along line 35-35 of FIG. 34 of a fastening element that couples the upper hopper bin to the two-piece base;

FIG. 36 is a bottom perspective view of the dry material handling hopper bin and two-piece base;

FIG. 37 is a top perspective view of the individual components of the hopper bin assembly separated from one another;

FIG. 38 is a bottom perspective view of the individual components of the hopper bin assembly separated from one another;

FIG. 39 is a top perspective view of the two-piece base portion of the hopper;

FIG. 40 is a top plan view of the two-piece base portion of the hopper; and

FIG. 41 is a fragmentary view taken along line 41-41 of FIG. 40 of the upper piece of the two-piece base portion.

The drawing figures do not limit the present invention to the specific embodiments disclosed and described herein. The drawings are not necessarily to scale, emphasis instead being placed upon clearly illustrating the principles of the invention.

### DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

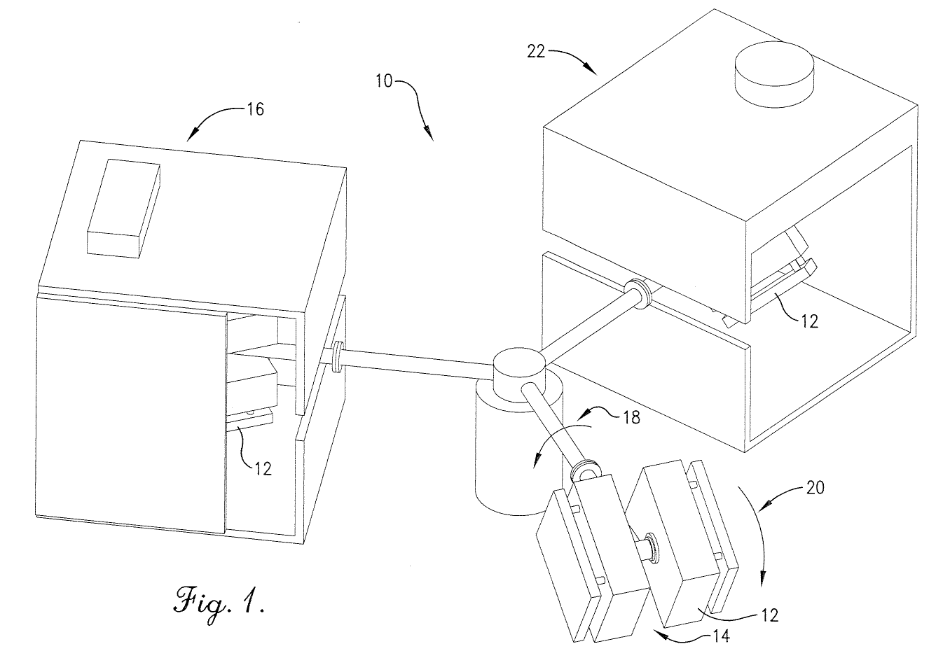

Referring now to the drawings, FIG. 1 is a schematic depiction of a rotational molding machine 10 which may be utilized in carrying out the present invention. Such rotational molding machines are known in the art and comprise a number of different stations, each of which performs a specific function. The polymer or plastic resin is first loaded into a mold 12 at the loading or charging station 14. The mold 12 is then moved into the oven or heating station 16, at which point it is subjected at the same time to heating and biaxial rotation. The directions of this biaxial rotation are depicted by the arrows 18, 20. The heating and rotating continue until all of the polymer has melted and adhered to the wall of the mold 12. The length of time the mold 12 remains in the oven 16, the temperature of the oven and the speed of biaxial rotation are determined by the polymer being used, as well as the overall wall thickness of the desired end product. As an example, the temperature in the oven 16 can be in the range of 600-700° F., and the mold 12 can remain in the oven for 25-40 minutes.

After sufficient heating, the mold 12 is next moved to an intermediate or pre-cooling station (not shown). The mold 12 then enters the cooling station 22, which can be cooled by means such as a fan or the like, where it continues to rotate so the part or parts retain an even wall thickness. As the mold 12 is cooled, the polymer solidifies, and the part eventually shrinks away from the walls of mold, making it easy to remove. As with the heating stage of the process, the rate, temperature and length of time of cooling in the cooling station 22 is critical to the end product. Finally, the mold 12 enters the unloading station (not shown), where the rotationally molded piece is released from the mold 12.

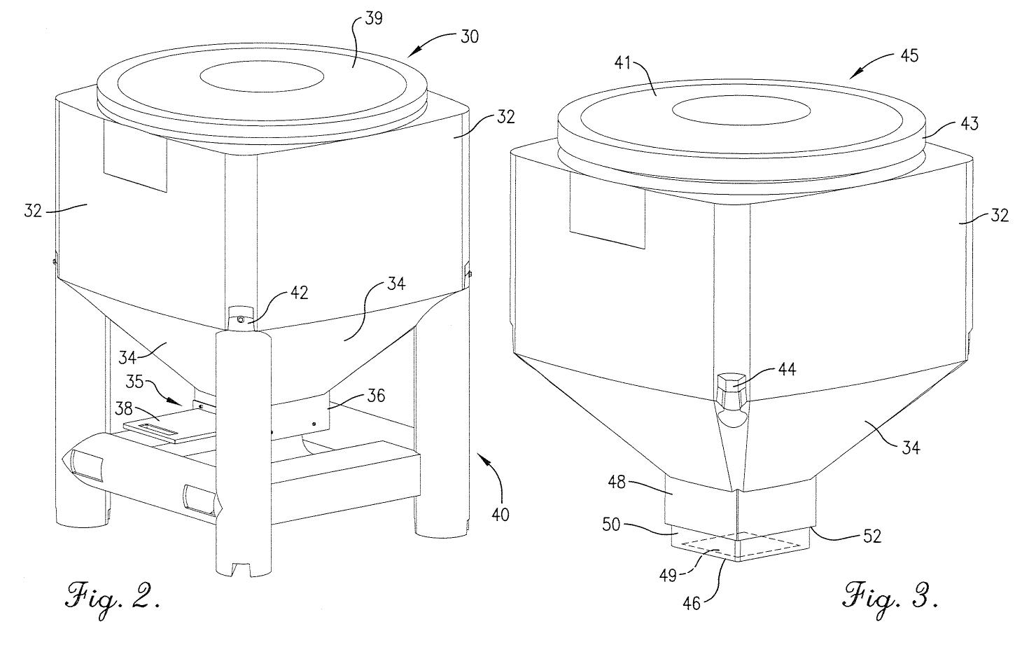

As illustrated in FIG. 2, a dispensing hopper container 30 is supported by a stand 40. Fasteners 42 of any suitable design securely attach hopper container 30 to the upper ends of the upright legs of stand 40. The upper portion of hopper container 30 is generally rectangular and is formed by four upright side walls 32, while a lower portion of hopper container 30 is frustoconical and is formed by four downwardly and inwardly converging side walls 34. Material discharging from hopper container 30 gravitates through an outlet valve housing 36 at the bottom of side walls 34, and such discharge is controlled by a valve assembly 35 that includes a horizontally shiftable slide gate 38. A removable lid 39 covers an access opening (not shown) at the top of hopper container 30.

In accordance with the present invention, hopper container 30 and portions of valve assembly 35 may be rotationally molded as a single, integral body. In this respect FIG. 3 illustrates a one-piece, hollow body 45 immediately following its removal from the rotational molding machine and prior to trimming and assembly operations that will transform it into finished hopper container 30, complete with valve assembly 35. Initially, body 45 is closed at both of its top and bottom ends. Body 45 also includes integrally molded receivers 44 that are ultimately utilized in attaching the legs of stand 40 to finished container 30, such receivers being the subject of Patent Application Publication No. 2006/0277783 which is hereby incorporated by reference into the present specification.

When outlet housing 36 is initially molded as a part of body 45, it is provided with a pair of rectangular, coaxial sections 48 and 50 as illustrated in FIG. 3. Upper section 48 is of larger transverse dimensions than lower section 50, thus presenting an offset transition or shoulder 52 at its intersection with section 50. Sections 48, 50 have generally the same cross-sectional shape, whether that shape be square, rectangular, circular, or other, with the diameters or widths of these sections being graduated in size. The external width dimensions of lower section 50 are slightly smaller than the internal width dimensions of upper section 48. Body 45 as it comes out of the mold also includes a temporary, discardable web 49 that closes and spans the lower end 46 of section 50.

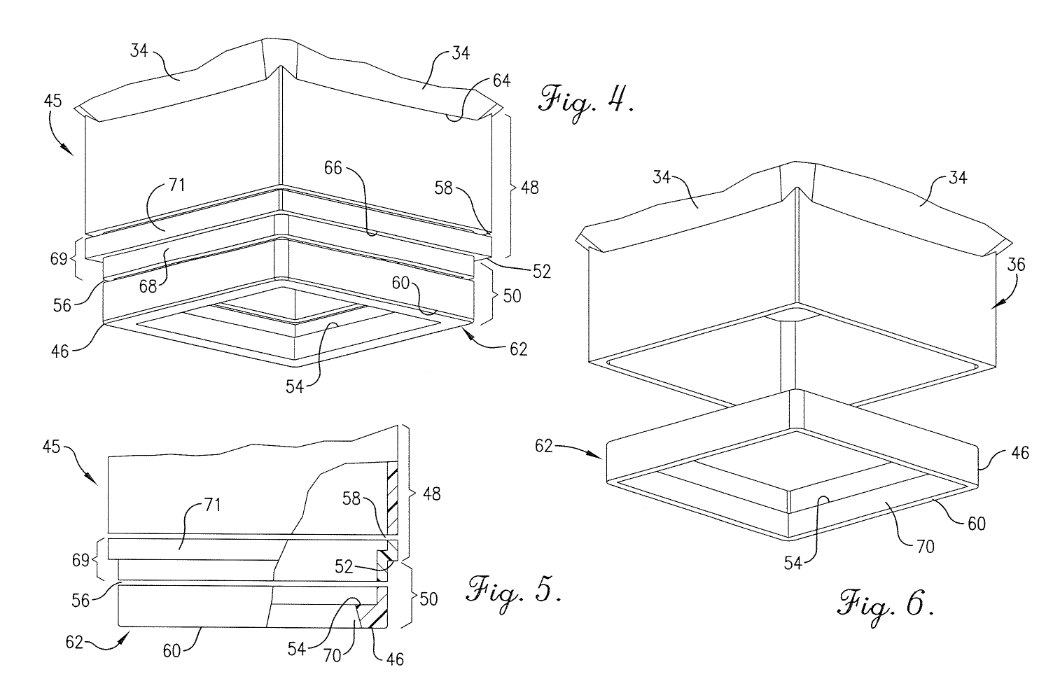

With reference to FIGS. 4 and 5, after body 45 is removed from the mold the web 49 is severed from lower section 50 and discarded to leave a rectangular opening 54 in section 50. The bottom end 46 is preferably provided with an upwardly and inwardly sloped wall 70 that terminates at the opening 54. Bottom end 46 can also be straight and devoid of sloped wall 70 if desired. Opening 54 is generally the same shape as the cross-sectional shape of outlet housing 36 but of smaller dimensions.

After web 49 is removed, a lower portion defining a rectangular annulus 62 is trimmed from section 50 at a cut 56 and removed, leaving an upper portion 68 still attached to section 48. Cut 56 is made between the transition 52 and a bottom edge 60 of section 50. The removed annulus 62 is saved as it will later be re-assembled with outlet housing 36 to serve as a slide support for slide gate 38, as hereinafter explained. Then a second transverse cut 58 is made through section 48 between a top edge 64 and a bottom edge 66 thereof, forming a rectangular, annular scrap piece 69 from the transition region between sections 48 and 50, which piece 69 can be discarded. The portion of section 48 that remains behind after scrap piece 69 is removed forms the outlet housing 36.

It should also be noted that the closed upper end 41 of body 45 can be transformed into lid 39 of finished container 30 by making a pair of appropriate, horizontal, vertically spaced trim cuts across the entirety of the upright, circumferential wall 43 of closed end 41 in a stepped region thereof. This detaches lid 39 from the rest of the body but enables it to be replaced on a smaller diameter, upwardly projecting rim remnant around the created opening at the top of container 30.

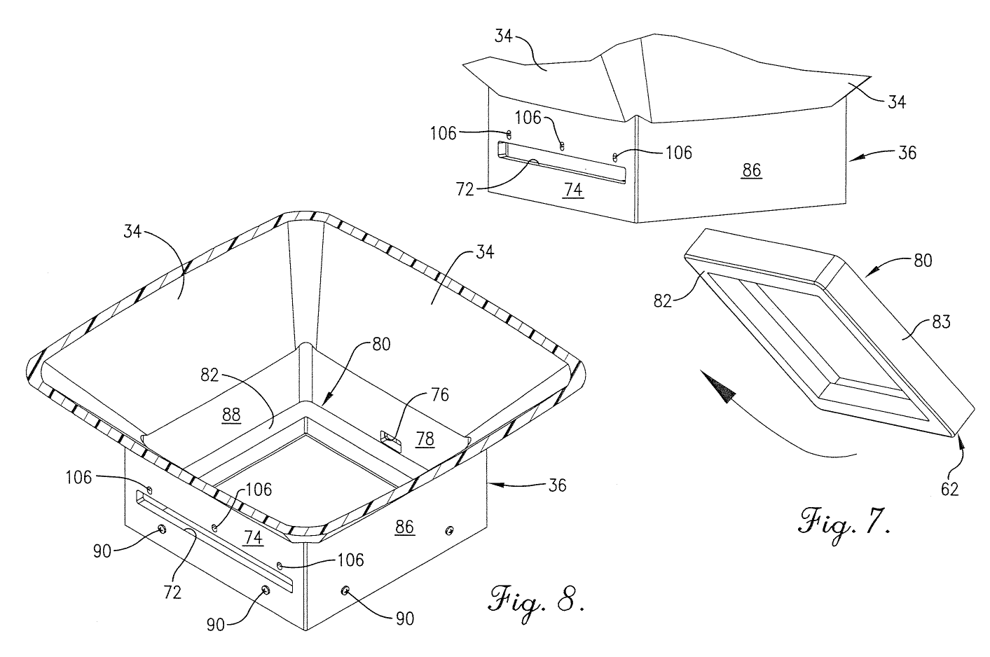

As shown in FIG. 7, after scrap piece 69 has been removed, a wide, horizontal, rectangular slot 72 is formed in a front wall 74 of outlet housing 36 by means of a router or the like. A second, axially aligned, shorter horizontal slot 76 (FIG. 8) is also formed in an opposed rear wall 78 of outlet housing 36. As will be discussed in more detail below, it is important for slots 72, 76 to be properly aligned, both side-to-side and front-to-rear.

As noted above, in accordance with the present invention previously removed annulus 62 of section 50 is advantageously utilized as a support for slide gate 38 when annulus 62 is re-assembled with outlet housing 36. To accomplish this objective, annulus 62 is first inverted 180° from the position it was in when molded as part of body 45. FIG. 7 illustrates annulus 62 in the process of being inverted, following which it is inserted into outlet housing 36 until what was previously the bottom edge 60 of annulus 62 is positioned flush with the bottom of slots 72, 76. Annulus 62 thereupon becomes a part of valve assembly 35, specifically a slide gate support platform 80, whose top surface 82 comprises what was previously the bottom of annulus 62. In addition to a top surface 82, slide platform 80 also has outer walls 83 that are positioned adjacent the inner surface of outlet housing 36.

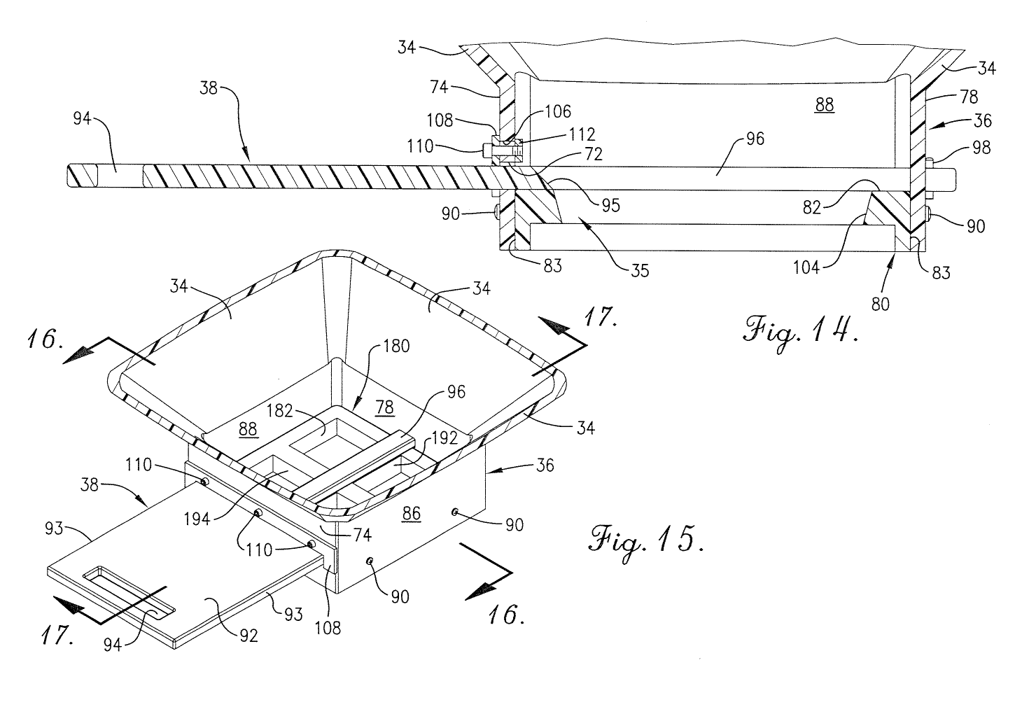

Outlet housing 36 includes a front wall 74, a spaced rear wall 78, and a pair of opposed sidewalls 86, 88 that span front and rear walls 74, 78. Due to the fact that the inside width dimensions of outlet housing 36 are only slightly greater than the outside width dimensions of slide platform 80, outer walls 83 are positioned adjacent the inner surface of front and rear walls 74, 78, and sidewalls 86, 88 of housing 36, as clearly depicted in FIGS. 13 and 14. A pair of screws 90 or other securing means in each wall 74, 78, 86, and 88 of outlet housing 36 pass through such walls and into slide platform 80 to securely fasten platform 80 to housing 36.

Turning now to FIGS. 9-14, it may be seen that slide gate 38 includes a large, rectangular flow-blocking panel 92 and an elongated guide tongue 96 that projects symmetrically beyond an inner end of panel 92. Panel 92 has a pair of laterally spaced, opposite side edges 93 and a width that is slightly less than the width of slot 72. Tongue 96 has a width that is slightly less than the width of slot 76. A rectangular opening 94 adjacent the outer end of panel 92 serves as a handle for manipulating slide gate 38. A leading edge 95 of panel 92 is chamfered to present an upwardly facing bevel which facilitates movement of the slide gate 38 into a closed position when outlet housing 36 is full of dry material during use.

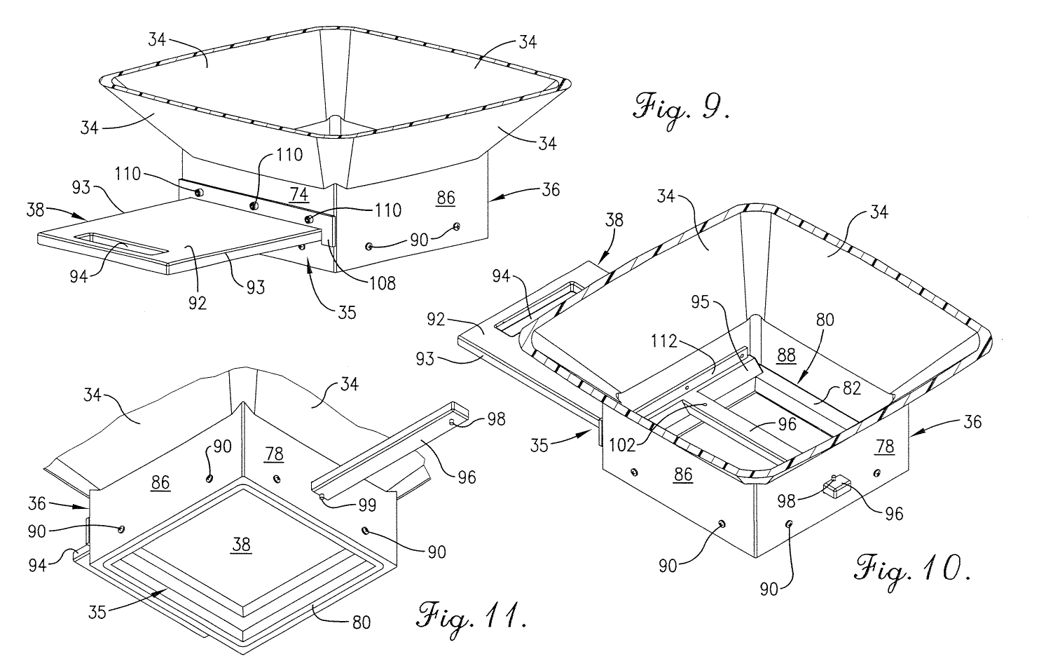

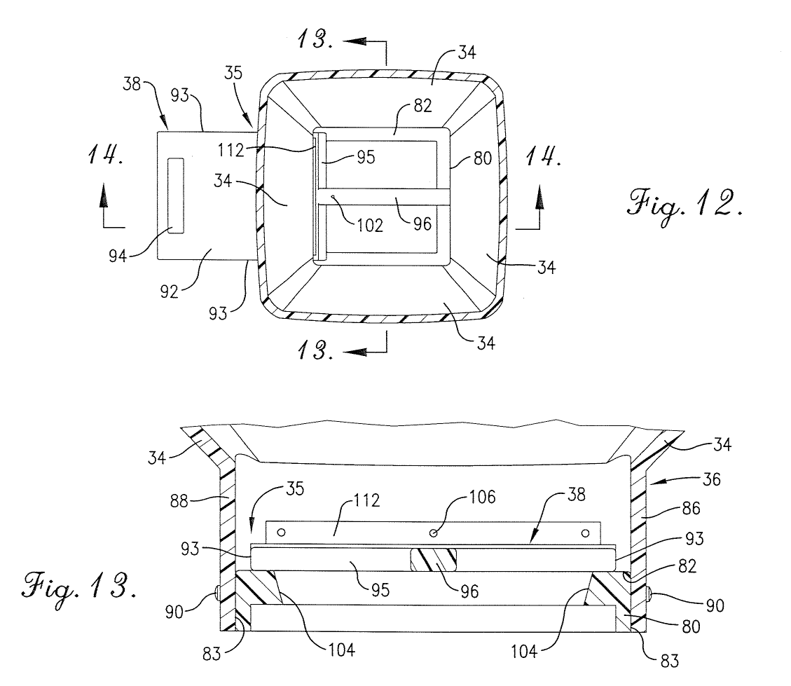

Slide gate 38 is positioned for use within outlet housing 36 by first passing tongue 96 through slot 72, and then through slot 76. As seen best in FIGS. 10 and 12, slide gate 38 is configured so that when tongue 96 extends at least partially through slot 76, leading edge 95 extends at least partially through slot 72. Lateral margins of panel 92 adjacent side edges 93 overlie and are slidably supported by top surface 82 of slide platform 80. In this manner, top surface 82 of slide platform 80 creates a support and guide surface for slide gate 38.

Once slide gate 38 has been installed in outlet housing 36, a stop pin 98 may be inserted through the distal end of tongue 96 to prevent gate 38 from accidently being completely withdrawn from housing 36. Correspondingly, a hole 102 adjacent the inboard end of tongue 92 may be utilized to selectively and removably receive its own stop pin 99 (FIG. 11) when gate 38 is fully closed so as to releasably retain gate 38 in the closed position.

In an alternative embodiment, outlet housing 36 includes only a first slot 72. In this variation, slide gate 38 is modified so as not to include a tongue, wherein when gate 38 passes through the inner portion of outlet housing 36 to its closed position, leading edge 95 is adapted to abut rear wall 78, effectively sealing the material from passing further through the hopper.

Turning now to FIGS. 13 and 14, the relative positioning of slide platform 80 within outlet housing 36 is detailed, along with the shape of platform 80. As discussed above, platform outer walls 83 are adjacent to and extend along the inner surface of housing walls 74, 78, 86, 88, and are secured in place by means of screws 90. Slots 72, 76 are positioned such that slide gate 38 moves along and is supported by top surface 82 of slide platform 80. Platform 80 further includes flanged extension 104 (which is the same as sloped wall 70 of lower portion 62 of molded body 45) which is spaced from outer wall 83 and extends inwardly and downwardly from top surface 82. As material flows through outlet housing 36 when slide gate 38 is in the open position, flanged extension 104 helps direct the material toward the center of the outlet. Also, when slide gate 38 is in this open position, tongue 96 extends across the outlet such that material flowing through outlet housing 36 can be broken up by tongue 96 as it flows past.

Front wall 74 further includes a number of seal apertures 106 above slot 72, as best seen in FIGS. 7, 8, and 14. A covering seal plate 108 is provided to account for any spaces which may exist between the slide gate 38 and slot 72, and is shaped to extend along the top and down the side edges 93 of slide gate 38. Seal plate 108 is secured to front wall 74 of sleeve 36 by means of fasteners 110 which extend through apertures in seal plate 108, and continue through corresponding seal apertures 106 of wall 74 and into corresponding apertures in a securing plate 112, which is positioned adjacent the inner surface of front wall 74. It is understood that any suitable sealing means can be utilized in an effort to prevent any material contained within the hopper 34 and outlet housing 36 from leaking out. Similarly, suitable sealing means can be used to seal any spaces between tongue 96 and slot 76 in rear wall 78.

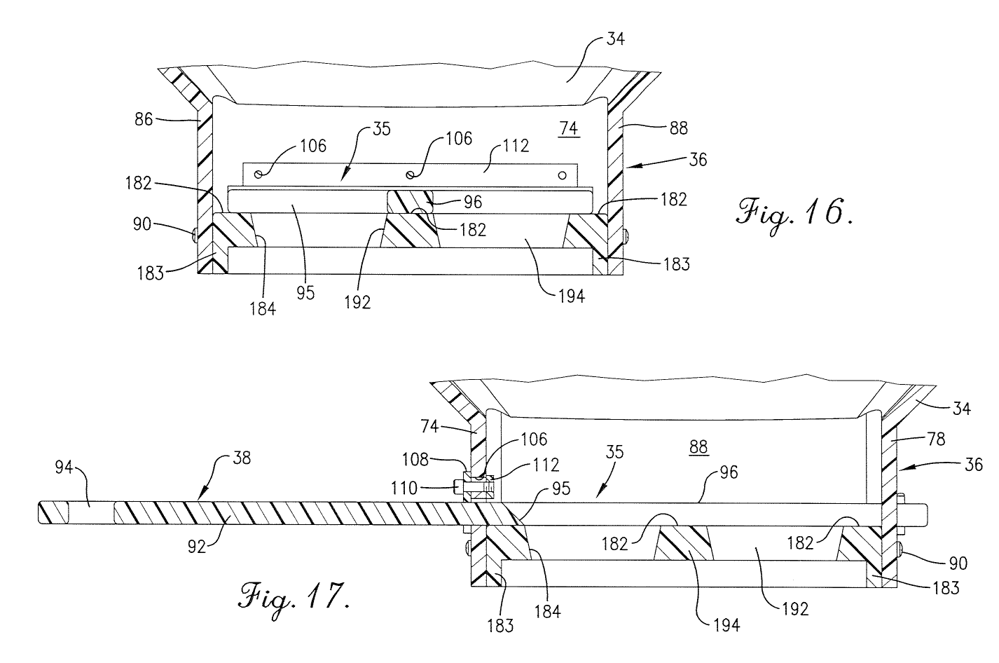

Turning next to FIGS. 15-17, an alternative gate slide platform 180 is depicted, wherein platform 180 includes top surface 182, outer walls 183, and flanged extension 184, similar to those corresponding features in slide platform 80. In addition, slide platform 180 includes additional support features, namely a pair of intersecting cross bars 192, 194. In particular, cross bar 192 provides increased support to tongue 96, and both cross bars 192, 194 provide increased support to panel 92 of slide gate 38. Both panel 92 and tongue 96 are otherwise subject to bending under the weight of the material passing through the hopper 34. In addition to increased support, these bars 192, 194 also function to break up clusters of the material as it passes through hopper 34 and outlet housing 36 when slide gate 38 is in an open, or partially open position.

As understood by those skilled in the art, the size, thickness and type of material used for the slide gate 38 may be any suitable size or material for any given application. As an example, slide gate 38 may be constructed from plywood, metal or polyethylene, and may be ½″ to ¾″ thick. Moreover, the resin utilized may be any suitable material, and for example may be selected based on desired melting points, strength characteristics, etc. An example of a suitable resin is a high density linear polyethylene.

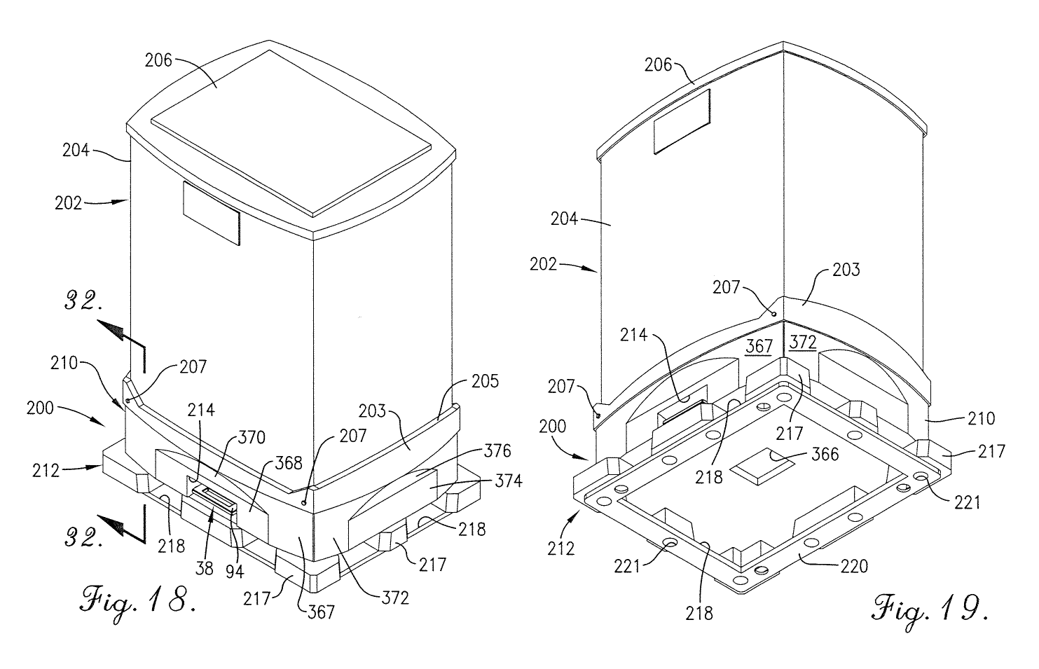

Referring now to FIGS. 18, 19, and 29-33, a part which may be rotationally molded in accordance with another aspect of the present invention comprises a base 200, which is designed for attaching to the open lower end of a tall, dry material hopper bin 202. Hopper bin 202 generally comprises an upright bin sleeve 204 and a lid 206 that closes the otherwise open top of sleeve 204. Sleeve 204 and base 200 are so designed that the lower end of sleeve 204 slips over and thus receives the upper extremity of base 200 when those two parts are joined together to produce the final assembled product. As will be seen, base 200 has an upwardly facing edge that bears against and supports a corresponding downwardly facing, interior shoulder on sleeve 204 when the two parts are assembled together.

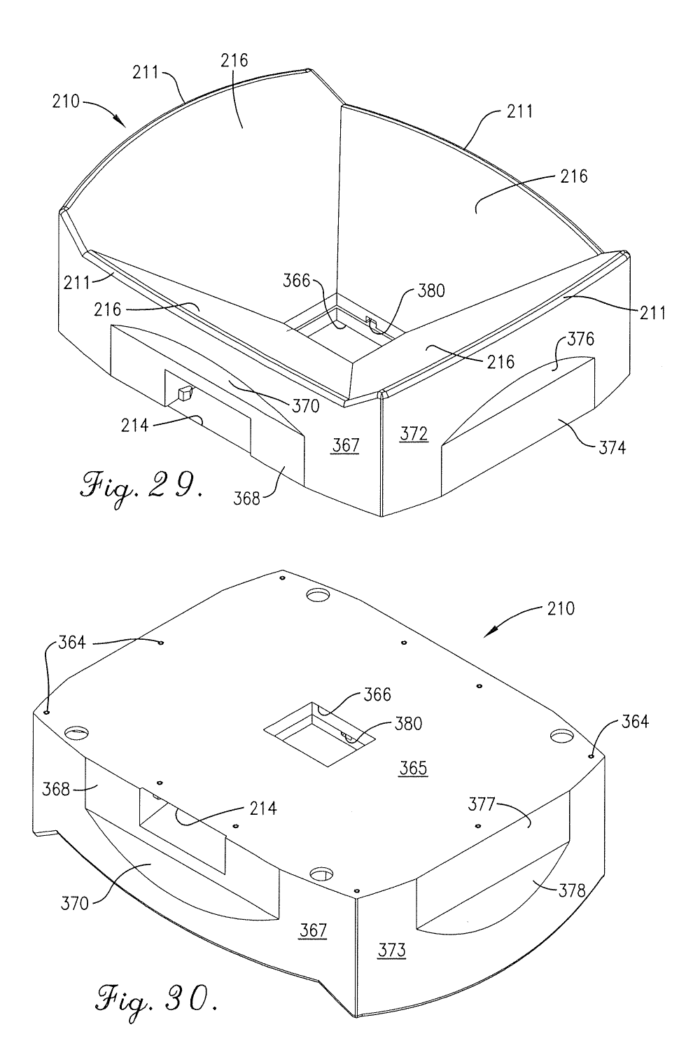

Base 200 generally comprises two pieces, namely, an upper section which is a slide gate housing 210 (detailed in FIGS. 29 and 30), and a lower section which is a pallet 212 (detailed in FIGS. 31 and 33). Slide gate housing 210 generally includes an integrally molded, side-entry slide gate opening 214 and downwardly and inwardly sloped flanges 216 which form the sloped bottom of the dry material bin 202 when bin sleeve 204 is positioned on base 200. Pallet 212 generally includes a fork lift pocket arrangement comprising a rectangular series of horizontally spaced-apart, upwardly projecting feet 217 about the perimeter of the pallet that define a corresponding series of pocket openings 218 therebetween. The pair of pocket openings 218 on each side of pallet 212 are adapted to receive the forks of a fork lift vehicle (not shown) when bin 202 is to be handled. Pallet 212 further includes an open, rectangular bottom frame 220 to which the feet 217 are affixed. Frame 220 provides stability and aids in handling to prevent bin 202 from tipping off a forklift during sudden stops or on a downhill slope.

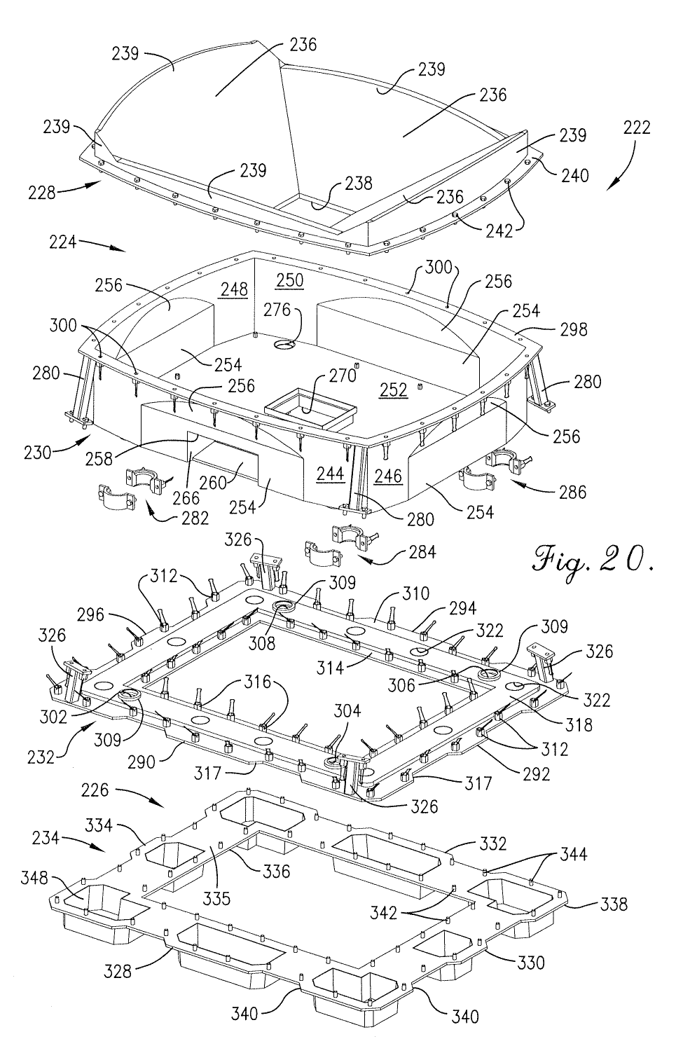

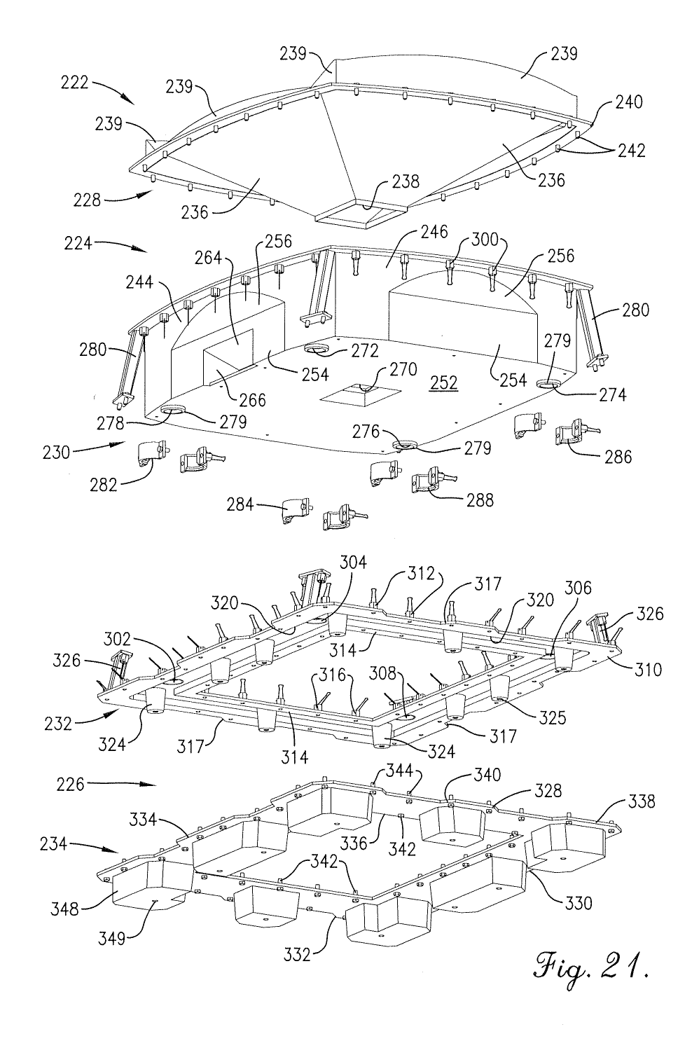

Turning now to FIGS. 20-21, a rotational mold 222 is illustrated which is configured for rotationally molding in its mold cavities the two-piece base 200. Mold 222 includes at least two compartments, shown here as gate housing mold compartment 224 and pallet mold compartment 226. Housing mold compartment 224 further includes two sections, namely a gate housing top section 228 and a gate housing bottom section 230, while pallet mold compartment 226 likewise includes two sections, namely a pallet top section 232 and a pallet bottom section 232.

Top section 228 of housing mold compartment 224 includes four sloped flanges 236 converging inwardly and downwardly to a centrally disposed opening 238, shown here as rectangular in shape, although any desired shape may be utilized. Flanges 236 are generally trapezoidal in overall shape and are provide with upward extensions 239.

Top section 228 also includes a flat peripheral ledge 240 along the bottom periphery of upper extensions 239, the ledge 240 having a plurality of fasteners 242, shown here as coupling bolts, that are adapted to be received by corresponding fasteners in bottom section 230. The upper periphery of top section 228 is shaped to form the desired shape of the upper portion of the slide gate housing 210, which is adapted to support sleeve 204 of hopper bin 202 as hereinafter explained in more detail.

Bottom section 230 of compartment 224 includes a front wall 244, a pair of opposite side walls 246, 248, and a rear wall 250. Such walls cooperate with a floor 252 to define a generally rectangular basin. Each wall curves slightly outwardly in a convex fashion, and is generally rectangular in shape.

Each wall 244-250 has a centrally disposed flat, generally rectangular segment 254 that is provided with an overhead beveled arch 256 which inclines outwardly and upwardly from segment 254 to meet with other portions of the wall. The rectangular segment 254 in front wall 244 further includes a recess 258 designed to form an opening in the wall 244. As best seen in FIG. 26, recess 258 is defined by four walls 260, 262, 264, and 266 converging inwardly from wall 244 and terminating at a back wall 268. The interior surface of back wall 268 will have a non-stick surface, such as a polytetrafluoroethylene block or the like, secured thereto, as will be described in more detail below, to ultimately form the slide gate opening 214 in the molded slide gate housing 210. As best seen in FIG. 18, recess 258 can be suitably sized to allow slide gate 38 to enter the hopper far enough that the distal end of the handle portion 94 of the gate 38, while still accessible by the operator, does not extend beyond front wall 367 when the slide gate 38 is in its closed position. With recess 258 appropriately sized, a bin operator can easily access the handle portion 94 of slide gate 38 even when gate 38 is in its closed position.

Floor 252 of lower compartment section 230 includes an opening 270, designed to be received in mating relationship with opening 238 in top section 228. These openings will define the hopper outlet opening in the molded base 200. In addition, bottom section 230 further includes four exteriorly disposed securing braces 280 that extend downwardly from each corner of ledge 298. The braces 280 include fastening means adapted to secure gate housing mold compartment 224 and pallet mold compartment 226 together during the molding process.

Floor 252 of lower section 230 is further provided with four apertures 272, 274, 276 and 278 adjacent the four corners thereof. On the underside of floor 252, each aperture 272-278 is provided with an axially aligned, downwardly projecting ring 279 or the like that is adapted to be received by the upper end of a corresponding coupling spacer. Although any suitable coupling spacers with non-stick characteristics can be utilized in accordance with this invention, coupling spacers are depicted herein as collars 282, 284, 286, and 288, coated with or constructed from a material to which the molding material will not adhere. The opposite end of each of the collars 282-288 is designed to receive and retain corresponding rings in the top section 232 of pallet mold compartment 226, as will be described below.

Gate housing bottom section 230 also includes a ledge 298 along the upper periphery thereof having a plurality of fastener means 300 in the form of fastener clips. Fastener means 300 are positioned and adapted to receive corresponding fasteners 242, such as coupling bolts, positioned in holes on ledge 240 of gate housing top section 228. During use, top section ledge 240 and bottom section ledge 298 are designed to flatly abut one another, secured together by means of fasteners 242 and 300.

Turning next to the pallet mold compartment 226, top section 232 includes an open, rectangular box frame having four sides, 290, 292, 294, and 296. Side 290 is provide with two apertures 302, 304 therein, while opposite side 294 is similarly provided with a pair of apertures 306, 308 therein. Each aperture is provided with an upwardly projecting, circumscribing ring 309 that is shaped and positioned to be matingly received by the lower end of a corresponding one of the coupling collars 282, 284, 286 and 288.

As illustrated in FIG. 28, coupling collars 282-288 create a tubular fluid flow path between the inner chambers of gate housing compartment 224 and pallet compartment 226, allowing granular and melted molding material to flow from the gate housing compartment 224 through collars 282, 284, 286 and 288 and into pallet compartment 226 during molding operations. The inner surfaces of collars 282, 284, 286, and 288 are coated with a non-stick substance such as polytetrafluoroethylene or the like, or have a non-stick block 289 secured thereto, to which the molding resin will not adhere during the rotational molding process.

A flat outer ledge 310 extends along and around the outer periphery of top section 232 and is provided with a plurality of spaced fasteners 312, shown here as fastener clips, adapted to receive corresponding fasteners in bottom section 234. Similarly, an inner ledge 314 extends along and around the inner periphery of top section 232 and includes a plurality of spaced fasteners 316, also depicted as fastener clips, adapted to receive corresponding fasteners in bottom section 234. Outer ledge 310 is also provided with four securing braces 326 extending upwardly from each corner thereof, positioned and adapted to mate with corresponding securing braces 280 of housing compartment 224. The braces 326 include fastening means adapted to mate with the fastening means of braces 280, to secure pallet mold compartment 226 to gate housing mold compartment 224 during the molding process. Ledge 310 is provided with a plurality of spaced, beveled notches 317 around the perimeter thereof.

Positioned between ledge 310 and ledge 314 on the top side of top section 232 is a wide, flat ridge 318, which forms a corresponding recess 320 on the bottom side thereof, as best seen in FIG. 21. A plurality of spaced apertures 322 pass through ridge 318, and a corresponding plurality of hollow, frustoconical members 324 are axially aligned therewith and extend downwardly from recess 320. Each frustoconical member 324 has a central, axially extending aperture 325 in a lowermost, transverse wall thereof.

The bottom section 234 of pallet compartment 226 also includes an open rectangular box frame having four corresponding sides 328, 330, 332, and 334. Bottom section 234 also presents an upper surface 335. The shape of inner perimeter 336 and outer perimeter 338 correspond with the shape of the inner perimeter of ledge 316 of top section 232 and the outer perimeter of ledge 310 of top section 232, respectively, with outer perimeter 338 including a series of correspondingly spaced beveled notches 340. Positioned adjacent inner and outer perimeters 336, 338 are a plurality of spaced fasteners 342, 344, respectively, which are adapted to receive corresponding fasteners 316, 312 on top section 232. During use, top section inner and outer ledges 310, 312 and upper surface 335 of bottom section 234 flatly abut one another, secured by means of fasteners 316, 312 and 342, 344, respectively. As will be understood from referring to the figures, during the molding process, this part of the configuration allows resin to enter recess 320, and thereby form bottom frame 220 of pallet 212.

A plurality of upwardly opening cavities 348 are formed in the top side of bottom section 234. Each cavity 348 has an aperture 349 through the recessed floor thereof and is adapted to receive a corresponding frustoconical member 324 of upper section 232. Apertures 349 are positioned to register with to apertures 325 in frustoconical members 324. Cavities 348 are positioned on opposite sides of notches 340 and, during the molding process, form feet 217 of pallet 212.

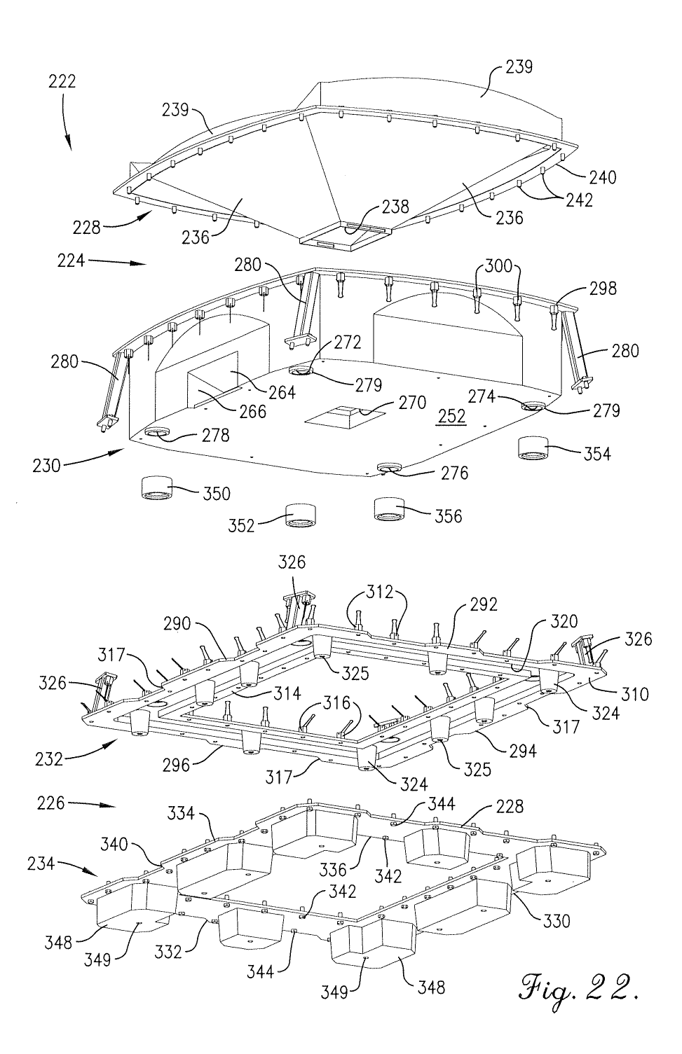

A modified version of the mold of the present invention is depicted in FIG. 22, where like reference numerals denote like parts. The variation in this embodiment is directed to the coupling spacers, which are depicted herein as short tubes 350, 352, 354, 356. These tubes 350-356 are formed from, lined or coated with a material to which the molding material will not adhere, such as a polytetrafluoroethylene block or the like. As depicted in FIGS. 21-22, each aperture 272-278 of bottom section 230 of housing compartment 224 is adapted to register and matingly communicate with the upper ends of coupling tubes 350, 352, 354, 356 respectively by means of rings 279. The lower ends of the tubes 350-356 are designed to mate with corresponding apertures 302-308 in the top section 232 of pallet compartment 226 by means of rings 309, as described above.

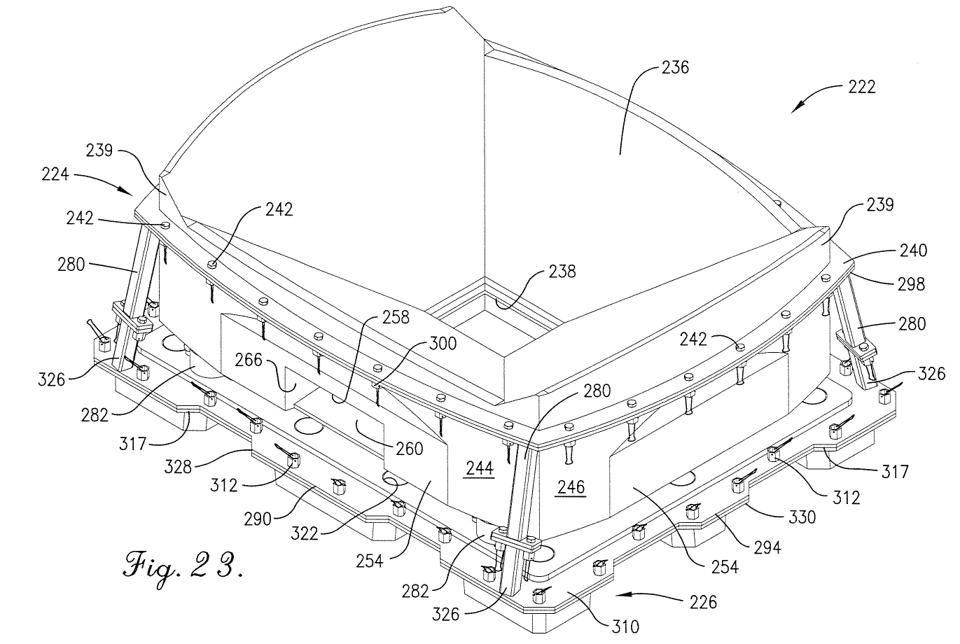

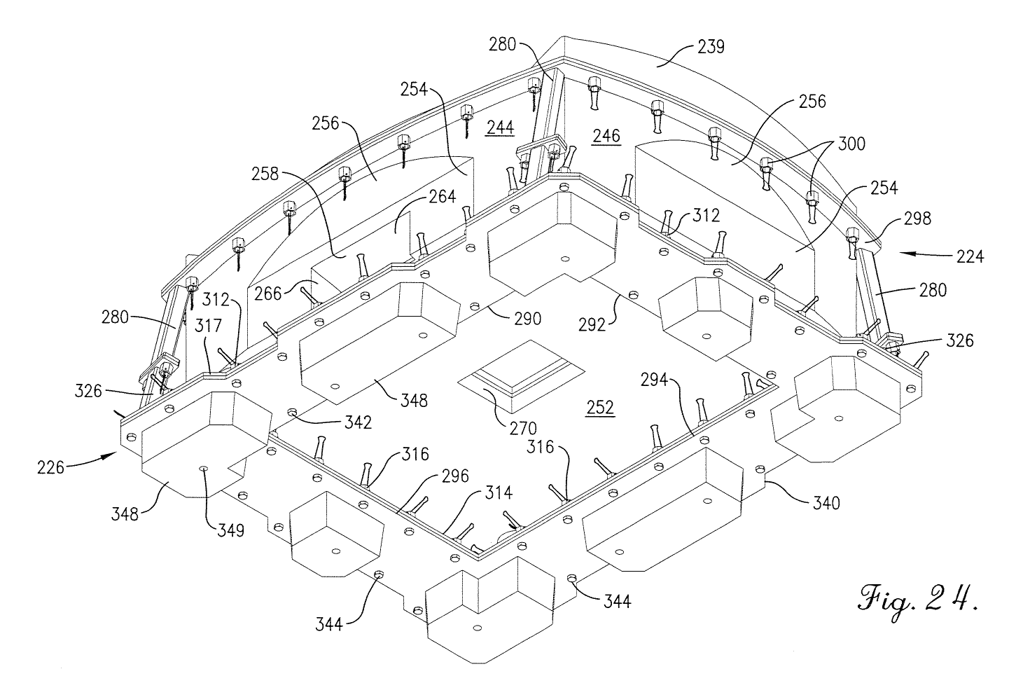

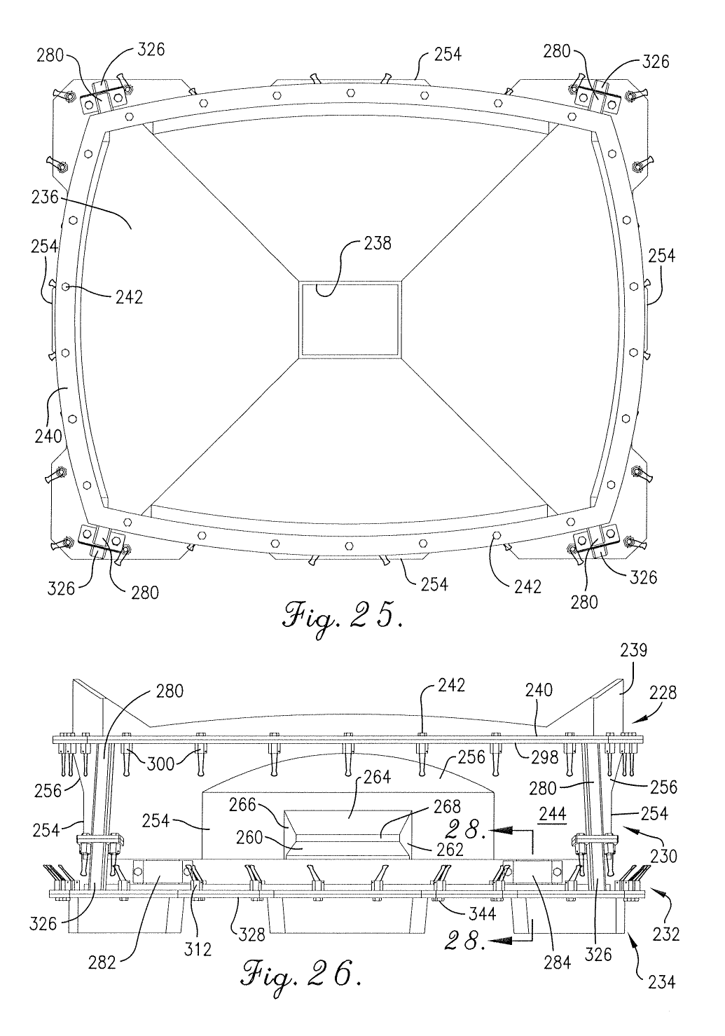

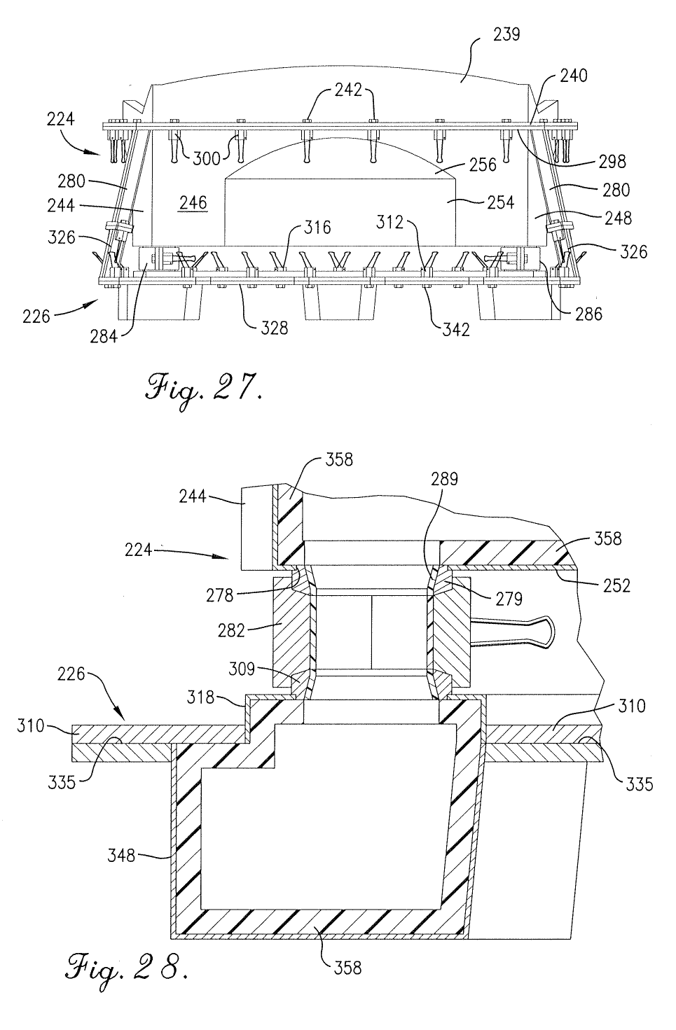

Turning next to FIGS. 23-27, the top and bottom sections 228, 230 of gate housing compartment 224 are first secured together, as are the top and bottom sections 232, 234 of pallet compartment 226. In the gate housing compartment, ledge 240 is correspondingly shaped as, and abuts against, ledge 298, secured by fasteners 242, 300. In the pallet compartment, inner ledge 314 and outer ledge 310 abut against upper surface 335 of bottom section 234, and are secured together by means of fasteners 316, 312 and 342, 344, respectively. Similarly, the outer perimeter of ledge 310 and the outer perimeter of upper surface 335 are correspondingly shaped with spaced, beveled notches 317, 340. Gate housing compartment 224 and pallet compartment 226 are then secured together by means of securing braces 280, 326, and are spaced apart and placed in fluid communication by means of the coupling spacers.

The mold sections are typically manufactured of mild steel, stainless steel or aluminum, which provide good strength-to-weight and good heat conductivity, with the thickness varying based on the size of the part and the material being used. Typically, the material is between about 1/16 to ½ inch thickness. The collars 282, 284, 286, 288 or tubes 350, 352, 354, 356, as well as the non-stick surfaces or blocks, are generally made from materials having a low thermal conductivity, so that as the mold is heated, the low thermal conductivity material will not likewise heat up, preventing the resin from adhering to it. In some instances, polytetrafluoroethylene is useful, particularly when the parts being molded are thin-walled, requiring a relatively lower molding temperature. However, when temperatures reach a certain high level, polytetrafluoroethylene can heat up, causing the resin to adhere thereto. Accordingly, when relatively high temperatures are used, as when molding thicker walled parts, non-stick materials such as ceramic are used. In some instances, low conductivity metals are useful for creating non-stick surfaces during the molding process.

In use, powdered synthetic resin such as polyethylene is placed within the upper mold compartment 224, although liquid polymer or other synthetic resins could also be used as a starting material. The mold sections 228 and 230 are then secured together by bolts or other fastener means. Similarly, mold sections 232 and 234 of pallet compartment 226 are then secured together as described above. Gate housing compartment 224 is coupled with and spaced from pallet compartment 226 by coupling spacers such as collars 282, 284, 286, 288 or tubes 350, 352, 354, 356, and then the compartments 224, 226 are secured together by fastening means on securing braces 280, 326. Mold compartments 224, 226 are then secured to a rotational molding machine, as is conventional, and placed in a heated room or oven where the temperature is above the melting temperature of the resin. As the mold 222 is rotated on two or more axes, the resin travels from upper compartment 224 through the tubular coupling spacers and into lower compartment 226, and becomes distributed throughout both compartments of the mold 222. The room is heated, for example, to about up to 700° F., and consequently the heat of the room is transferred to the metal mold 222. As the temperature of the mold 222 rises, the synthetic resin begins to melt and collect on the inner mold walls. The synthetic resin is not heated to a fully liquefied state, but rather to a thick viscous molten condition.

After the powdered resin is sufficiently melted and distributed so that the resin is deposited to the inner surface of the mold walls as desired, the mold 222 is removed from the heated room, but rotation of the mold 222 continues during cooling to maintain an even thickness of the deposited resin. Once the mold 222 is sufficiently cooled, either by exposure to ambient air or water spray if necessary in hot climates, so that the resin is solidified and self sustaining, the mold 222 may be removed from the rotating arm or left in place, and the mold sections uncoupled so that the parts 210 and 212 may be removed.

FIG. 28 depicts fragmentary portions of gate housing mold compartment 224 and pallet mold compartment 226 having resin 358 deposited therein. As is readily apparent, non-stick block 289 prevents resin 358 from adhering to collars 282, so that slide gate housing 210 can be easily separated from pallet 212 when gate housing mold 224 and pallet mold 226 are uncoupled and the respective molded pieces 210, 212 are removed.

FIGS. 29-33 show the slide gate housing 210 and the pallet 212 which are formed within the mold 222 by the deposit of the resin 358 thereon. The resin 358 coats the inner surface of the mold 222, except for those portions formed of or covered with a block formed of a non-stick surface, such as polytetrafluoroethylene or the like, which prevents the material from adhering to those specific selected areas. The back wall 268 formed by the juncture of walls 260, 262, 264, 266 utilizes such a non-stick block, which prevents the resin material from adhering in that specific area, thereby forming the opening though which the slide gate 38 slides.

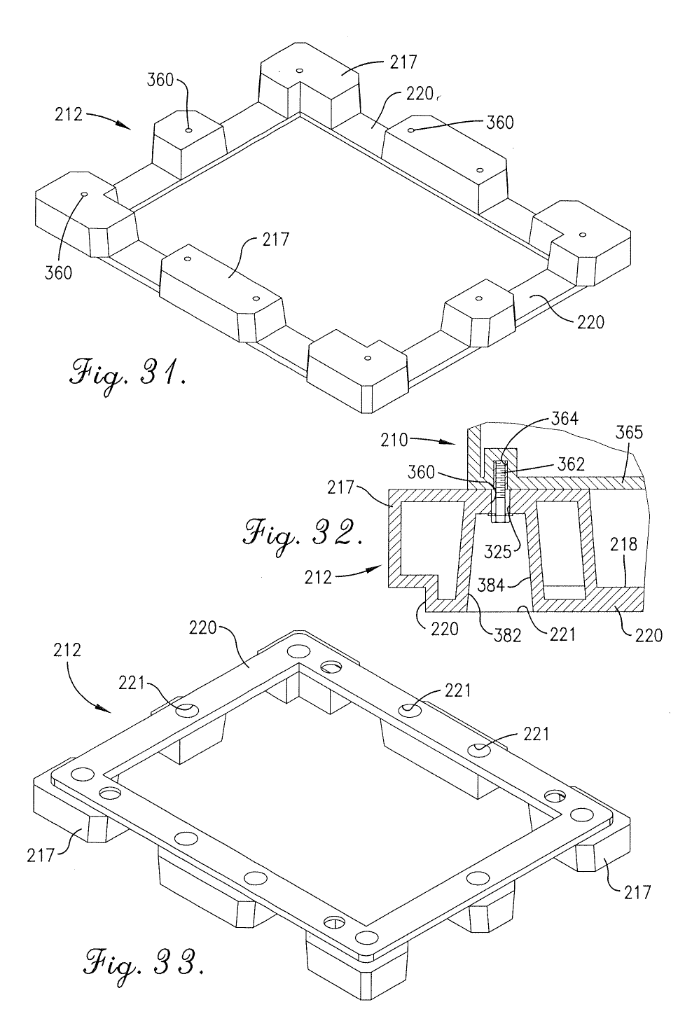

FIG. 32 fragmentarily depicts pallet 212 secured to slide gate housing 210. Connecting apertures 360 in the upper surface of each foot 217 are adapted to receive one end of a fastener 362, such as a bolt or the like, and corresponding connecting apertures 364 along the periphery of floor 365 of slide gate housing 210 are adapted to threadably receive a second end of fastener 362, thereby securing slide gate housing 210 to pallet 212, as depicted in FIGS. 18 and 19. FIGS. 32-33 further illustrate the shape inside each foot 217 formed by frustoconical members 324. Specifically, aperture 221 is formed in bottom frame 220, and upwardly and inwardly sloping walls 382, 384 extend inside foot 217 from bottom frame apertures 221 to terminate adjacent aperture 325. Aperture 325 is in communication with corresponding fastener inlet 364, both of which are adapted to receive fastener 362 therein. Walls 382, 384 provide added strength to feet 217, and consequently to base 200.

FIGS. 29-30 depict the slide gate housing 210 formed in accordance with the process of the present invention. Sloped flanges 216 form the sloped bottom of hopper bin 202 when bin sleeve 204 is positioned on base 200 and converge downwardly to terminate at outlet 366. Housing 210 presents an uppermost peripheral edge 211 for supporting bin sleeve 204 as hereinafter explained in more detail.

Front wall 367 curves slightly outwardly and includes a recessed, relatively flat segment 368 having a beveled arch 370 thereabove, arch 370 sloping outwardly and upwardly from flat segment 368 to meet front wall 367. Flat segment 368 includes gate slide opening 214. Across from the slide gate opening side of outlet 366, a slide gate tongue opening 380 is included for receiving the tongue of a slide gate, as discussed in detail above regarding FIGS. 1-17.

Side wall 372 similarly curves slightly outwardly and includes a flat segment 374 having a beveled arch 376 thereabove, sloping outwardly and upwardly from flat segment 374 to meet side wall 372. The rear wall (not shown) and opposite side wall 373 similarly are curved slightly outwardly and have flat segments 377 and corresponding beveled arches 378 therein.

Floor 365 of slide gate housing 210 contains a plurality of spaced connecting apertures 364 for coupling housing 210 with pallet 212. Sloped flanges 216 of slide gate housing 210 form the sloped bottom of the dry bin 202 and the opening for the slide gate 214 as a single unit.

FIGS. 31 and 33 depict the pallet 212 formed in accordance with the process of the present invention. Feet 217 are spaced along bottom frame 220. The spaces between feet 217 are adapted to receive the forks of forklifts between bottom frame 220 of pallet 212 and floor 365 of gate housing 210. These forklift pocket openings 218 defined by feet 217, bottom frame 220, and floor 365 are adapted to provide stability to the base 200 and hopper bin 202 assembly by providing an anti-teeter feature which aids in handling without the bin tipping off the forks during a sudden stop or on a downhill slope. This combination base 200 with anti-teeter features and built-in slide gate housing 210 is designed to be utilized as a common base for any selected one of a number of bin sleeves of different heights. Such sleeves are molded as separate parts from base 200 in a variety of different heights, permitting the user to select the height necessary or desirable for the particular application at hand and to readily combine it with the common base 200, whose dimensions remain the same regardless of which sleeve is selected for use. The sleeve height is based on the length of the bin sleeve mold, which can be adjusted easily by adding an extension sleeve or sleeves of the necessary length to produce the desired part, without any need to change the dimensions of the slide gate housing 210.

As illustrated in FIGS. 18, 19, sleeve 204 has a marginal skirt 203 around the lower periphery thereof that is offset outwardly a short distance from the main body portion of the sleeve. The interior transverse dimensions of sleeve 204 at skirt 203 are slightly greater than the exterior transverse dimensions of housing 210 such that housing 210 is received within skirt 203 and skirt 203 overlaps the exterior of housing 210 when sleeve 204 is placed upon base 200. A peripheral shoulder 205 is defined at the junction between skit 203 and the main body of sleeve 204 corresponding in contour to the upwardly facing edge 211 of housing 210 (FIG. 29). Thus, shoulder 205 presents a downwardly facing interior surface that bears against and is supported by the upwardly facing edge 211 of housing 210 when bin 202 is placed upon base 200. Screws 207 (FIGS. 18, 19) or the like may be installed in skirt 203 to securely connect skirt 203 to the exterior walls of housing 210.

It is contemplated that sleeve 204 and lid 206 may be molded as a one-piece part. In this respect lid 206 may initially comprise an integral portion of skirt 203 at the bottom of sleeve 204. Lid 206 is then trimmed from skirt 203 and placed on the otherwise open top end of sleeve 204.

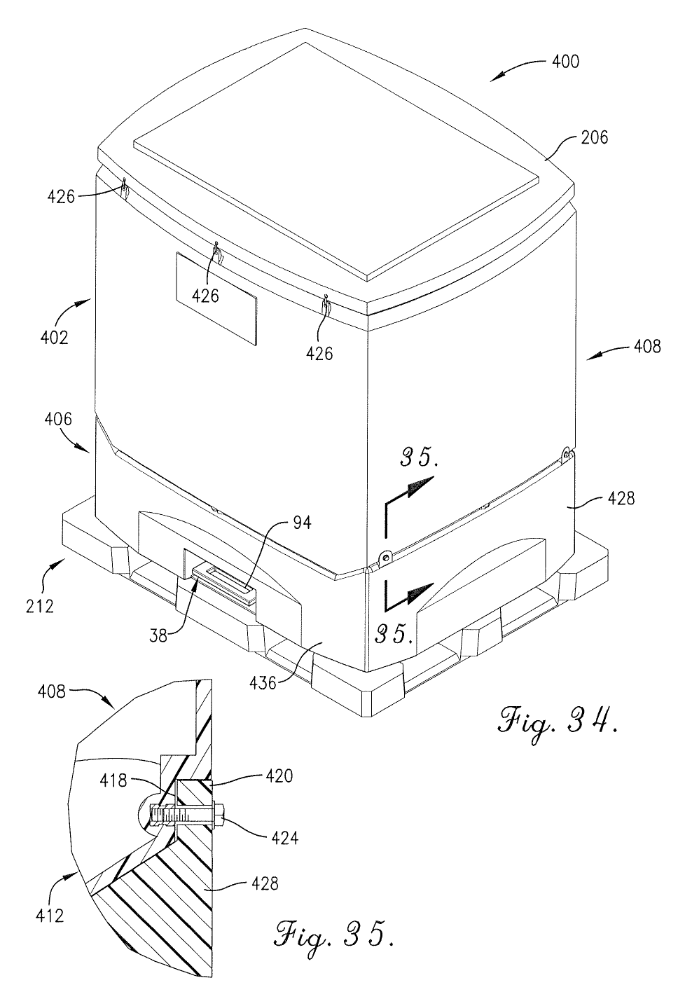

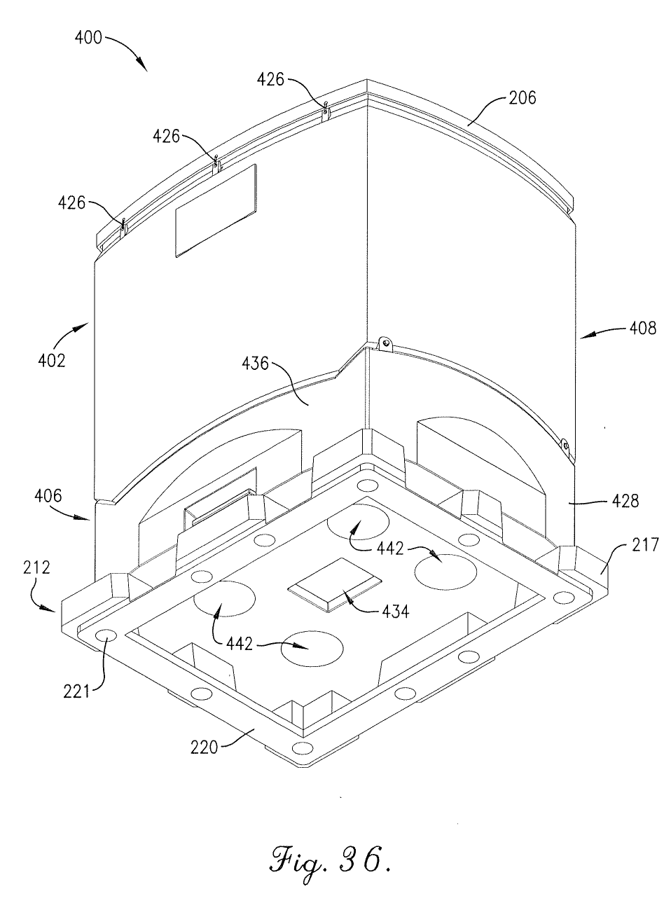

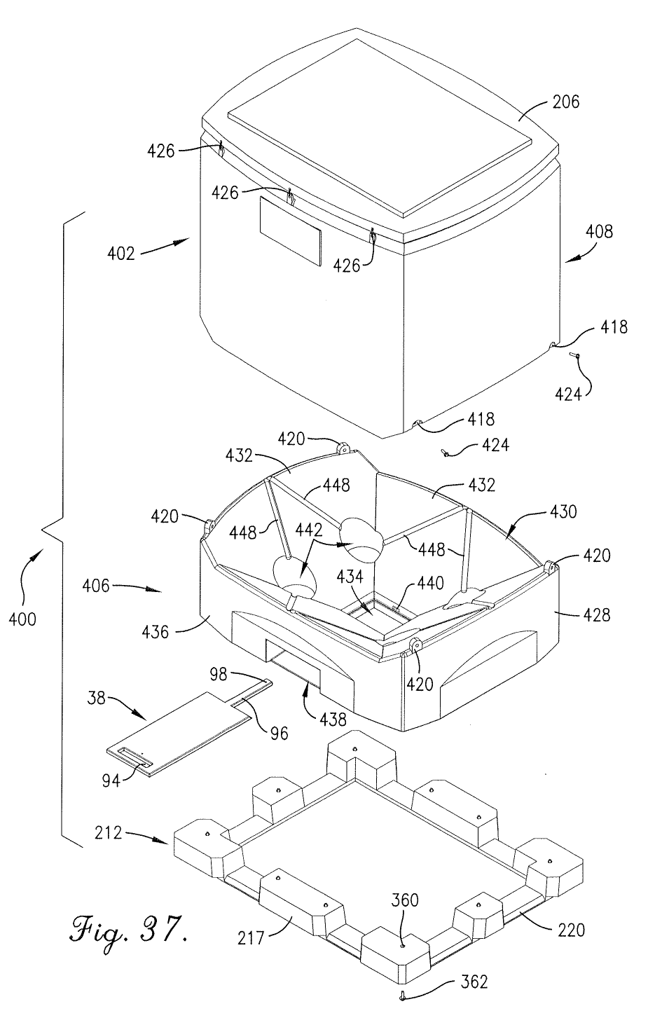

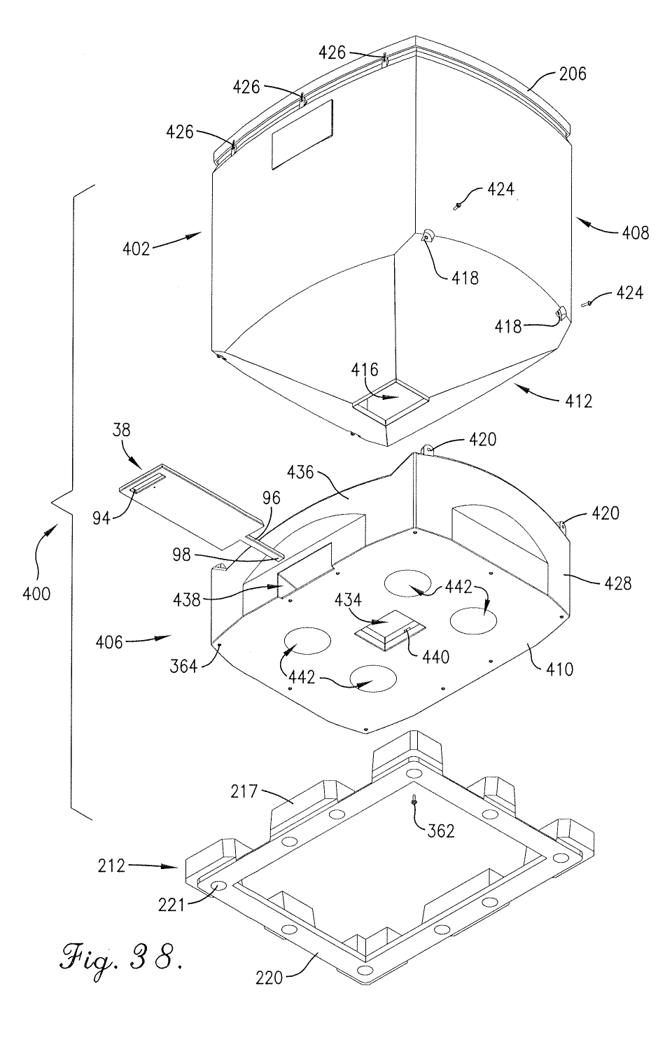

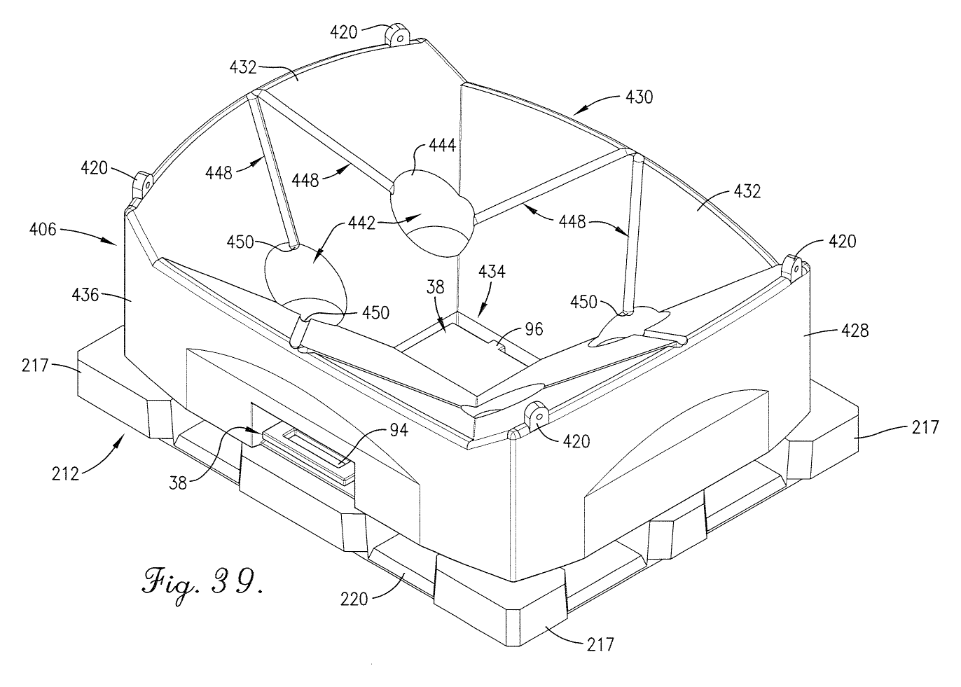

Referring now to FIGS. 34-41, a hopper bin assembly 400 is shown which comprises alternate embodiments of the hopper bin 402 and the slide gate housing 406, and an embodiment of the pallet 212 that is substantially similar to the embodiment shown in FIGS. 29 and 30. As is seen in FIGS. 34 and 36-38, the hopper bin assembly 400 includes the hopper bin 402 on the top, the slide gate housing 406 in the middle, and the pallet 212 on the bottom. The assembly 400 is generally formed by stacking and fastening the hopper bin 402 to the slide gate housing 406 and then stacking and fastening the combination of the hopper bin 402 and the slide gate housing 406 to the pallet 212, or by stacking and fastening the slide gate housing 406 to the pallet 212 and then stacking and fastening the combination of the slide gate housing 406 and the pallet 212 to the hopper bin 402. The hopper bin assembly 400 is generally stored with the pallet 212 sitting on a storage surface, such as the floor of a warehouse.

As seen primarily in FIGS. 37 and 38, the hopper bin 402 may include a four-sided upper bin sleeve 408, which stores a large portion of the material. The bin sleeve 408 may include a generally rectangular cross-sectional shape in the horizontal plane, wherein the sides of the rectangle may be curved outward slightly away from the center. The hopper bin 402 may also include a frusto-pyramidal shaped lower funnel 412 with four tapering sides that are directly coupled to the four sides of the bin sleeve 408. At the bottom of the funnel 412 is a rectangular shaped funnel opening 416 through which material stored in the hopper bin 402 flows while it is being dispensed. On opposing sides of the hopper bin 402, at the boundary where the bin sleeve 408 and the funnel 412 meet, may be a plurality of indentations 418 in the hopper bin 402. These indentations 418 may be generally recessed in the body of the hopper bin 402 and may be shaped to receive a plurality of lugs 420 that are attached to the slide gate housing 406 as discussed below. The interior of each indentation may also include a hole to receive a screw 424.

Attached to the top of the hopper bin 402 may be the lid 206 as described above. A plurality of fastening elements 426 may couple the lid 206 to the top of the hopper bin 402.

As seen in FIGS. 37-40, the slide gate housing 406 may include four sides 428 with a generally rectangular cross section that is substantially the same size and shape as the hopper bin 402 described above. The slide gate housing 406 is generally positioned below the hopper bin 402 and may include an top funnel-receiving section 430 that is generally shaped to receive the funnel 412 of the hopper bin 402. Thus the slide gate housing 406 top section 430 may include four faces 432 that are inwardly and downwardly tapered to match the shape and pitch of the funnel 412 such that the surfaces of the funnel 412 and the top section 430 of the slide gate housing 406 generally make contact when the hopper bin 402 is stacked on top of the slide gate housing 406. Along the perimeter of the top section 430 of the slide gate housing 406 on opposing sides may be a plurality of lugs 420 that protrude upwardly from the slide gate housing 406. The lugs 420 may be shaped and positioned to match the indentations 418 of the hopper bin 402 such that when the hopper bin 402 is stacked upon the slide gate housing 406, the lugs 420 fit securely into the indentations 418. Furthermore, each tab may include a hole that aligns with the hole of the indentation to receive the screw 424 that fastens the hopper bin 402 to the slide gate housing 406, as seen in FIG. 35.

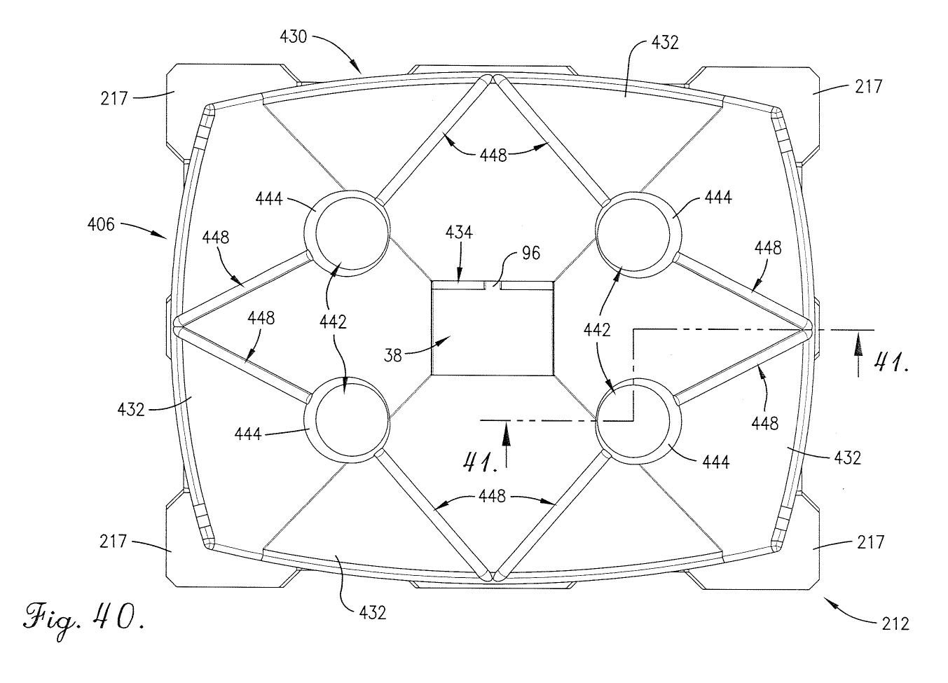

As best seen in FIG. 40, at the center of the top section 430 may be a rectangular-shaped discharge opening 434 that is similarly sized and positioned to align with the opening 416 at the bottom of the funnel 412. The discharge opening 434 passes vertically through the body of the slide gate housing 406 to the bottom 410 of the housing 406 to allow material stored in the hopper bin 402 to pass through the housing 406. The slide gate housing 406 may also include a front side 436 in which there is a slide gate opening 438 that connects from the front side 436 of the slide gate housing 406 to the discharge opening 434. The slide gate opening 438 may be sized and shaped to accommodate the slide gate 38 as described above. The slide gate 38 includes the handle 94 at the proximal end and the tongue 96 with the stop pin 98 at the distal end and is generally positioned within the slide gate opening 438. The slide gate housing 406 further includes a slot 440 that is located at the back of the discharge opening 434 and is sized to slidably receive the tongue 96. The slide gate 38 functions in a similar fashion as described above. The slide gate 38 normally sits within the slide gate opening 438 in an open position and a closed position. In the closed position, the handle 94 is conveniently accessible at the front side 436 of the slide gate housing 406 and the distal end of the gate substantially closes off the discharge opening 434 not allowing material that is stored in the hopper bin 402 to pass through. To change from the closed position to the open position, the handle 94 is pulled and the slide gate 38 slides forward, guided in part by the tongue 96 sliding through the slot 440, thus opening up the space of the discharge opening 434 and allowing material stored in the hopper bin 402 to pass through the opening 434, flowing on either side of the tongue 96. The slide gate 38 can be pulled forward until the stop pin 98 encounters the slot 440, at which point the slide gate 38 is completely open.

The slide gate housing 406 may also include a plurality of through holes 442 that extend from the faces 432 of the top section 430 to the bottom 410 of the slide gate housing 406. There may be four through holes 442, where each one is positioned approximately midway along a line from the center to each of the four corners of the slide gate housing 406. The location of each through hole 442 is also approximately in the center of a quadrant of the housing 406, if the housing 406 were divided into four equal-sized quadrants. Thus, each pair of adjacent through holes 442 lies along a path that the forks of a forklift would follow when lifting the hopper bin assembly 400, no matter whether the forks enter through the wider side or the narrower side of the slide gate housing 406.

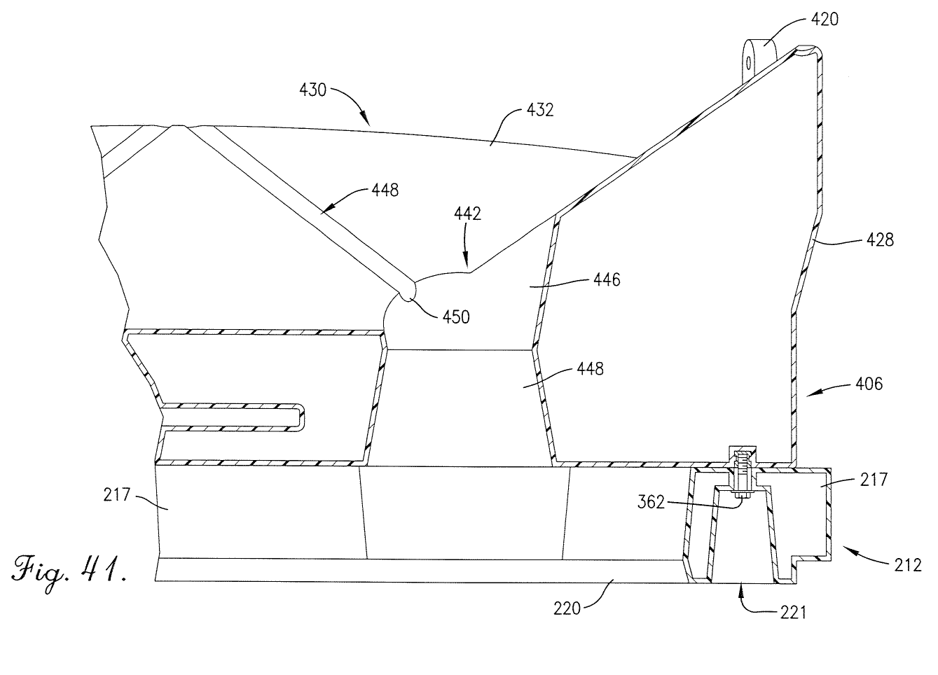

Each through hole 442 includes an upper portion 444 and a lower portion 446, wherein the upper portion 444 of the through hole 442 couples with one or more faces 432 of the top section 430 of the slide gate housing 406, and the lower portion 446 of the through hole 442 couples with the bottom 410 of the housing 406. The upper portion 444 may include sidewalls that have a frusto-conical cross-sectional shape with respect to a vertical plane through the center of the through hole 442, with the upper portion 444 narrowing slightly towards the center of the through hole 442, as seen in FIG. 41. The lower portion 446 may also include sidewalls that have a frusto-conical cross-sectional shape with respect to a vertical plane through the center of the through hole 442, with the lower portion 446 narrowing slightly towards the center of the through hole 442, also seen in FIG. 41. Given the near vertical component of the sidewalls of the through holes 442 and the positioning of the through holes 442 along the path of the forks of a forklift, additional, evenly-distributed structural strength is provided by the through holes 442 during transportation of the hopper bin assembly 400. The weight of the hopper bin 402, and the material therein, exerts a downward force on the top section 430 of the slide gate housing 406. When the hopper bin assembly 400 is being lifted and held during transport, the forks of the forklift exert an upward force on the bottom 410 of the slide gate housing 406. These two forces, acting on opposing ends of the slide gate housing 406, create a compressional force on the housing 406 in the vertical direction. The through holes 442 provide uniformly-distributed structural support in the vertical direction, particularly in the areas of forklift contact, to counteract the compression.

The slide gate housing 406 may also include a plurality of water channels 448 at each side of the slide gate housing 406. Each face 432 of the top section 430 may include two water channels 448, wherein the channels 448 extend from the center of the upper edge of the face 432 downward toward the center of the two closest through holes 442. Each water channel 448 may be a trough 450 with a generally U-shaped cross section, wherein the top of the trough 450 is at the surface and the bottom of the trough 450 is below the surface of each face 432 of the top section 430 of the slide gate housing 406. The water channels 448 may carry water from the sides 428 of the slide gate housing 406 to the through holes 442, where the water simply falls through the slide gate housing 406 and lands on whatever surface is below the hopper bin assembly 400. Thus, the water channels 448 serve to guide water away from the discharge opening 434 at the center of the slide gate housing 406 and direct it to the through holes 442, so that water contact with the material being discharged from the hopper bin assembly 400 is reduced.

The pallet 212 has substantially the same structure and is coupled to the slide gate housing 406 in the same manner as the embodiments that are shown in FIGS. 31-33 and described above.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of making a dispensing hopper container comprising the steps of:
rotationally molding a hollow body having a converging side wall portion and a discharge outlet portion extending integrally from the converging side wall portion as a continuation thereof,
said outlet portion having first and second axially aligned, annular sections of mutually different transverse dimensions and an annular transition section between said first and second sections in which the outlet portion changes dimensions from said first section to said second section;
preparing an axial outlet opening in said second section;
severing the second section from the outlet portion;
severing the transition section from the outlet portion,
said first section being adapted to permit said second section to be inserted into the first section in coaxial relationship therewith;
inserting the second section into the first section in coaxial relationship therewith and securing the second section to the first section; and
preparing a side entry opening in said first section above the second section for receiving a slide valve gate across said outlet portion that rests upon said second section during shifting of the gate between operated positions thereof.

2. A dispensing hopper container comprising:
a converging side wall portion;
an annular discharge outlet portion integrally joined to said converging side wall portion and projecting downwardly therefrom as a continuation thereof,
said discharge outlet portion having a discharge opening adjacent a lower end thereof,
an annular support received within said outlet portion;
a side entry opening in said outlet portion above said annular support; and
a slide valve gate received in said side entry opening and shiftably supported by said annular support for movement between operated positions thereof to control the discharge of material through said discharge opening.

3. A dispensing hopper container comprising:
a base having upwardly facing, downwardly and inwardly converging wall surfaces terminating at a central discharge opening,
said base further being provided with a shiftable gate for opening and closing said discharge opening; and
a separate, upright, tubular container sleeve mounted on and projecting upwardly from said base in such a manner that the interior of the sleeve is in direct superimposed relationship with said converging wall surfaces so that the converging wall surfaces effectively form a hopper bottom for the sleeve.

4. A method of making a dispensing hopper container comprising the steps of:
rotationally molding a base that includes an outlet housing having upwardly facing, downwardly and inwardly converging wall surfaces that terminate at a centrally disposed discharge opening;
providing said outlet housing with a shiftable gate for opening and closing said discharge opening; and
mounting any one of a number of different height container sleeves on said base in such a manner that the interior of the selected sleeve directly overlies the converging wall surfaces of the base and the converging wall surfaces effectively form a hopper bottom for the sleeve.

5. A base attachment for a dispensing hopper container comprising:
an outlet housing having upwardly facing, downwardly and inwardly converging wall surfaces that terminate at a centrally disposed discharge opening; and
a pallet attached to said outlet housing beneath the same and having a centrally disposed aperture aligned with said discharge opening of the outlet housing for allowing materials discharging from the housing to pass through the pallet,
said pallet having a generally rectangular bottom frame and a plurality of horizontally spaced apart feet projecting upwardly from said frame into engagement with said housing,
the spaces between said feet presenting pockets for the reception of lifting forks usable in the stable handling of an upright container formed by mounting a container sleeve onto said base.

6. A rotational mold for use in molding two separate parts in the same molding operation, said mold comprising:
a first mold compartment for molding the first of said two parts;
a second mold compartment for molding the second of said two parts; and
tubular connectors joining said first and second compartments together in such a manner that the interiors of said first and second compartments are disposed in flow communication with one another through said connectors,
said connectors being operable to avoid the adherence of molten plastic material thereto during the rotational molding process to permit the formation of two distinct and separate parts in the compartments.

7. A method of rotationally molding two separate and distinct parts in a single mold comprising the steps of:
providing a first mold compartment for molding the first of said two parts;
providing a second mold compartment for molding the second of said two parts;
joining said first and second compartments together using tubular connectors in such a manner that the interiors of said first and second compartments are disposed in flow communication with one another through said connectors; and
preventing the adherence of molten plastic material to the interior of the tubular connectors during the rotational molding process to permit the formation of two distinct and separate parts in the compartments.

8. A hopper bin assembly, said assembly comprising:
a hopper bin including an upper bin sleeve for storage of material and a lower funnel portion with a funnel opening;
a slide gate housing with four sides and including a top funnel-receiving section with a central discharge opening that aligns with the funnel opening, further including a plurality of through holes in the vertical direction located along a path of lifting forks to provide structural strength during transport of the assembly; and
a pallet including a generally rectangular bottom frame and a plurality of horizontally spaced apart feet projecting upwardly from said frame into engagement with the slide gate housing.

9. The assembly of claim 8, further including a slide gate slidably coupled with the discharge opening to control the flow of material through the discharge opening.

10. The assembly of claim 8, further including a plurality of water channels that extend from the sides of the slide gate housing to the through holes for carrying water away from the discharge opening.

11. The assembly of claim 8, wherein the spaces between the feet include pockets appropriately spaced for the reception of lifting forks.

12. The assembly of claim 8, wherein the assembly is formed with the placement of the slide gate housing on top of the pallet and the hopper bin on top of the slide gate housing.

13. A base attachment for a dispensing hopper container, said attachment comprising:
a slide gate housing with four sides and including—
a top hopper-receiving section with a central discharge opening that aligns with a hopper opening,
a slide gate slidably coupled with the discharge opening to control the flow of material through the discharge opening,
a plurality of through holes in the vertical direction located along a path of lifting forks to provide structural strength during transport of the assembly, and
a plurality of water channels that extend from the sides of the slide gate housing to the through holes for carrying water away from the discharge opening; and
a pallet including a generally rectangular bottom frame and a plurality of horizontally spaced apart feet projecting upwardly from said frame into engagement with the slide gate housing, wherein the spaces between the feet include pockets appropriately spaced for the reception of lifting forks.
